(19) United States
(12) Patent Application Publication
(10) Pub. No.: US 2020/0308080 A1
(43) Pub. Date: Oct. 1, 2020

(54) EXPLOSIVES COMPOSITION

(71) Applicant: Orica International Pte Ltd, Singapore (SG)

(72) Inventors: Tanesh Dinesh GAMOT, Vallabh Vidyanagar, Anand (IN); Mainak MAJUMDER, Dandenong North (AU); Arup Ranjan BHATTACHARYYA, Mumbai (IN); Fiona G BEACH, Black Hill (AU); Tamarapu SRIDHAR, Mt Waverley (AU); Kelly M ROBINSON, Clarence Town (AU)

(21) Appl. No.: 16/618,005

(22) PCT Filed: May 30, 2018
(86) PCT No.: PCT/SG2018/050267

§ 371 Date: Nov. 27, 2019

(30) Foreign Application Priority Data
May 30, 2017 (IN) 201741018967

(51) Int. Cl. C06B 47/14; C01B 32/198

(52) U.S. Cl. CPC C06B 47/145; C01B 32/198

(57) ABSTRACT

The present invention relates to a water-in-oil (W/O) emulsion explosive comprising one or more of graphene oxide (GO), partially reduced graphene oxide (prGO), and functionalized graphene oxide (fGO). There is also provided a method of improving one or more properties of a water-in-oil (W/O) emulsion explosive.

### FIELD OF THE INVENTION

This disclosure relates in general to explosives compositions for use in commercial blasting operations, such as mining and quarrying applications. Aspects of the present disclosure are directed to emulsion explosives containing one or more of grapheme oxide (GO), partially reduced graphene oxide (prGO), and functionalized graphene oxide (fGO).

### BACKGROUND OF THE INVENTION

The general thought in classical chemistry is that atoms and molecules are extremely small with the molar masses of less than 1000 g/mol, while in classical physics, these are macroscopic particles and can be understood in terms of physical mechanics. Fortunately, there are particles which reside between these extremes—the colloidal size range of particles, whose small sizes and high surface-area-to-volume ratios make the properties of their surfaces very important and lead to some unique physical properties.

A colloidal dispersion is a collection of particles, bubbles or droplets of one phase with molecular dimensions of up to several microns, dispersed in the second phase. Colloids are classified on the basis of whether they are solid or liquid, dispersed in solid or liquid or gas as sol, emulsion, foam, and aerosol.

Of all classes of colloids, emulsions are the most common. An emulsion is a type of a colloid in which both phases are in a liquid state. Emulsions are formed when two immiscible liquids are mixed and stabilised by a surfactant or emulsifier. The dispersed liquid in an emulsion exists as droplets in the continuous liquid of another composition.

For any emulsion, stability is the factor that decides the performance as well as the quality of the emulsion. Stability accounts for physical and chemical changes over time. For an emulsion explosive, good rheological properties and high thermal conductivity are required, along with stability.

An emulsifier is a surfactant that adsorbs to the surface of emulsion droplets; this facilitates the formation of an emulsion containing smaller droplets, and the stabilisation of the droplets. An emulsifier reduces the interfacial tension by forming a protective coating around the droplets during emulsification. This prevents the disruption of emulsion droplets; ultimately prevent it from aggregating and coalescence.

Emulsion can be classified based on volume percentage of internal phase or internal phase ratio (IPR) into three types namely, diluted, concentrated and highly concentrated emulsions. Highly concentrated emulsions are high internal phase emulsions that have a larger volume fraction of the dispersed phase in the continuous phase.

Emulsions have found applications in the making of diverse materials including commercial explosives. Emulsion explosives are composed of a discontinuous phase containing an oxygen- supplying component and an organic fuel medium, forming the continuous phase; both the phases are emulsified in the presence of a suitable emulsifier.

Owing to their significant industrial importance, considerable research has been conducted to date with a mind to developing new and/or improved emulsion explosives. An opportunity therefore remains to continue with such research to develop new and/or improved emulsion explosives.

### SUMMARY OF THE INVENTION

The present invention provides a water-in-oil (W/O) emulsion explosive comprising graphene oxide.

The present invention also provides a thermal conductivity enhanced water-in-oil (W/O) emulsion explosive comprising a W/O emulsion explosive composition having a thermal conductivity enhancement agent incorporated therein, wherein the thermal conductivity enhancement agent comprises graphene oxide.

In one embodiment the graphene oxide provides the thermal conductivity enhanced W/O emulsion explosive with a thermal conductivity that is up to 15% greater than that of the W/O emulsion explosive in the absence of graphene oxide.

In another embodiment the graphene oxide provides the graphene oxide provides the thermal conductivity enhanced W/O emulsion explosive with a thermal conductivity that is between 5-15% greater than that of the W/O emulsion explosive composition in the absence of graphene oxide.

In one embodiment the graphene oxide is incorporated into the W/O emulsion explosive composition as a surfactant, a surfactant-like component, or a surfactant adjuvant.

In one embodiment the W/O emulsion explosive composition further comprises a surfactant other than graphene oxide.

In another embodiment the W/O emulsion explosive exhibits an emulsion stability of up to 20 days.

In one embodiment the graphene oxide comprises at least one of graphene oxide per se, a partially reduced form of graphene oxide, and a functionalized graphene oxide.

The W/O emulsion explosive in to which the graphene oxide is introduced according to the invention can advantageously be a conventional W/O emulsion explosive. As described herein, upon addition of the graphene oxide to a conventional W/O emulsion explosive, certain properties of the resulting W/O emulsion explosive are enhanced, relative to the conventional W/O emulsion explosive (i.e. absent the graphene oxide).

The graphene oxide may be graphene oxide per se (GO), a partially reduced form of graphene oxide (prGO), and/or a functionalized graphene oxide (fGO). Examples of fGO include amine or amide functionalized graphene oxide. For ease of reference unless otherwise stated, reference to “graphene oxide” is intended to embrace these various possibilities.

In other words, the present invention provides a water-in-oil (W/O) emulsion explosive comprising one or more of graphene oxide (GO), partially reduced graphene oxide (prGO), and functionalized graphene oxide (fGO).

Similarly, the present invention also provides a thermal conductivity enhanced water-in-oil (W/O) emulsion explosive comprising a W/O emulsion explosive composition having a thermal conductivity enhancement agent incorporated therein, wherein the thermal conductivity enhancement agent comprises one or more of graphene oxide (GO), partially reduced graphene oxide (prGO), and functionalized graphene oxide (fGO).

The emulsion explosive comprises conventional components, namely aqueous oxidizer salt solution and fuel, and one skilled in the art will be familiar with the types of salt solutions and fuels that may be used. Such emulsion explosives are commonly known as water-in-oil (W/O) emulsion explosives. Embodiments can also rely on the use of conventional emulsifiers, and again one skilled in the art would understand the types of reagents that may be used in this regard.

The emulsion explosives in accordance with embodiments of the present disclosure may require sensitization before they are in a form that may be initiated. Hence, embodiments in accordance with the present disclosure encompass non-sensitized emulsion explosives.

Sensitization may be achieved by using conventional techniques, including the introduction of voids into the emulsion explosive. Thus, chemical gassing agents may be used to produce sensitizing gas bubbles in the emulsion explosive. Sensitization may also be achieved by inclusion of microballoons, typically glass or plastic microballoons.

Without wishing to be limited by theory it is believed the graphene oxide may function as a surfactant (emulsifier), a surfactant-like component, or a surfactant adjuvant in an emulsion explosive composition or emulsion explosive, thereby aiding stabilization of or stabilizing the emulsion explosive. In some embodiments, the emulsion explosive may include graphene oxide as the only surfactant. In such embodiments the graphene oxide may be used in the form of a dispersion of graphene oxide in a polar carrier/vehicle, for example in water, for instance, deionized water. In that case the emulsion can be formed by mixing together an aqueous oxidizer salt solution, a fuel and the dispersion of graphene oxide in a polar carrier/vehicle. In such embodiments the amounts of aqueous oxidizer salt solution and fuel phase will be conventional. It has been found that emulsions formed in that way can exhibit suitable emulsion stability (e.g., for up to 20 days).

For a given emulsion explosive under consideration, the amount of graphene oxide (and the amount of carrier/vehicle) may be determined experimentally, e.g., with respect to providing an emulsion explosive having suitable, intended, or desired emulsion characteristics and/or explosive properties.

In other embodiments, an emulsion explosive may be prepared using a conventional emulsifier in combination with graphene oxide (e.g., dispersed in a polar carrier/vehicle). In that case, the relative proportions of the emulsifier and graphene oxide may need to be controlled or carefully controlled since with respect to certain relative proportions, there may be an interaction between them (e.g., competitive interaction) that can be adverse with regard to emulsion characteristics and stability. In such an embodiment, the emulsion explosive may be prepared by mixing the (conventional) emulsifier with the fuel phase, and by blending the fuel/emulsifier mixture with an aqueous oxidizer salt solution and a dispersion of graphene oxide.

In some embodiments it has been found the presence of graphene oxide can provide beneficial properties in a sensitized emulsion explosive; specifically, the graphene oxide may provide improved or enhanced thermal conductivity relative to a conventional emulsion explosive in which graphene oxide is not present. The improvement in thermal conductivity may be up to about 15% and possibly higher.

An improvement in thermal conductivity may provide beneficial detonation characteristics in a fully formulated (sensitized) emulsion explosive. For example, improved velocity of detonation (VoD) may be achieved without comprising density.

In one embodiment the thermal conductivity of a pre-existing or pre-formulated emulsion explosive may be improved by blending the emulsion explosive to include graphene oxide.

The graphene oxide can be used in the form of a dispersion in a polar carrier/vehicle. Alternatively, the graphene oxide may be used in the form of powdered graphene oxide.

The present invention also provides a sensitized emulsion explosive comprising an emulsion explosive and graphene oxide

As disclosed herein, such a sensitized emulsion explosive can be sensitized by conventional means.

The present invention further provides a method of blasting in which the sensitized emulsion explosive is provided in a blasthole or borehole and initiated. The sensitized emulsion explosive may be initiated using conventional initiation devices.

In one embodiment, a sensitized first emulsion explosive containing graphene oxide can be loaded into a blasthole in a non-random, sequenced, or programmably-defined manner (e.g., in accordance with stored program instruction sets executed by a processing unit such as a microprocessor or microcontroller) with respect to the loading of a sensitized second emulsion explosive that lacks graphene oxide into the same blasthole, such that one or more portions of the blasthole contain the sensitized first emulsion explosive, and one or more other portions of the blasthole contain the sensitized second emulsion explosive.

The first and second sensitized emulsion explosives can be sensitized in the same manner (e.g., by way of the same sensitizing agent or agents), or in different manners (e.g., by way of different sensitizing agents), as will readily be understood by one of ordinary skill in the art. Moreover, in association with the sensitization of the first and/or second emulsion explosives by way of the introduction of sensitizing voids therein, sensitizing voids may be controllably introduced into the first and/or second emulsion explosives in a manner that respectively provides the first and/or second emulsion explosives with an intended or target density or density profile within the blasthole (e.g., a constant density profile, or a varying/variable density profile, possibly depending upon or as a function of depth within the blasthole).

Without wishing to be limited by theory, while it has been found in a number of embodiments the graphene oxide may function as a surfactant (emulsifier), a surfactant-like component, or a surfactant adjuvant in an emulsion explosive composition or emulsion explosive, the exact function or functions of graphene oxide in such emulsions is not completely understood, and may vary depending upon embodiment details. For example, the addition and blending of powdered or particulate graphene oxide into pre-formed or pre-formulated W/O emulsion explosive compositions (e.g., W/O emulsion explosive compositions that have been formulated such that all emulsification stage(s) for their preparation or manufacture are complete prior to the addition of the graphene oxide) has been found to provide surprising improvement in the VoD of such emulsion explosive compositions, even for small or very small amounts of added graphene oxide, relative to the W/O emulsion explosive compositions absent the graphene oxide. In such case, the addition of the graphene oxide into the pre-formulated W/O emulsion explosive composition at least up to a graphene oxide weight percentage of 5% does not appear to interfere with the emulsion stability of the pre-formulated W/O emulsion explosive composition, which is emulsified by way of conventional surfactant material(s). This, in turn, can indicate that the graphene oxide need not or may not function solely or to any great extent as a surfactant (emulsifier), a surfactant-like component, or a surfactant adjuvant; the graphene oxide may in addition or outright function as one or both of a thermal conductivity agent and a chemical sensitizing agent or further chemical sensitizing agent.

The present invention therefore also provides use of graphene oxide to improve one or more properties of a W/O emulsion explosive, relative to the W/O emulsion explosive absent the graphene oxide.

Improved properties of the W/O emulsion explosive may, for example, include improved thermal conductivity and/or improved velocity of detonation.

The present invention further provides use of graphene oxide to improve thermal conductivity of a W/O emulsion explosive, relative to the W/O emulsion explosive absent the graphene oxide.

The present invention further provides use of graphene oxide to improve velocity of detonation of a W/O emulsion explosive, relative to the W/O emulsion explosive absent the graphene oxide.

The present invention also provides a method of improving one or more properties of a W/O emulsion explosive, the method comprising incorporating in the W/O emulsion explosive graphene oxide, wherein said one or more improved properties is relative to the W/O emulsion explosive absent the graphene oxide.

The graphene oxide may be incorporated into the W/O emulsion explosive during or as part of an emulsification stage of preparing the W/O emulsion explosive.

Alternatively, the graphene oxide may be incorporated into the W/O emulsion explosive after an or after all emulsification stage(s) of preparing the W/O emulsion explosive. In that case, the graphene oxide may be described as being incorporated into a pre-formed or pre-formulated W/O emulsion explosive (e.g., the graphene oxide is an additive to the pre-formulated W/O emulsion explosive).

The present invention also provides a method of improving thermal conductivity of a W/O emulsion explosive, the method comprising incorporating in the W/O emulsion explosive graphene oxide, wherein said improved thermal conductivity is relative to the W/O emulsion explosive absent the graphene oxide.

The present invention further provides a method of improving velocity of detonation of a W/O emulsion explosive, the method comprising incorporating in the W/O emulsion explosive graphene oxide, wherein said improved velocity of detonation is relative to the W/O emulsion explosive absent the graphene oxide.

In one embodiment, the thermal conductivity of the W/O emulsion explosive may be improved by an amount of at least about 5%, or at least about 10%, or at least about 15%, or at least about 20%. For example, the thermal conductivity of the W/O emulsion explosive may be improved by an amount ranging from about 5% to about 25%, or from about 10% to about 20%.

In another embodiment, the velocity of detonation of the W/O emulsion explosive may be improved by an amount of at least about 5%, or at least about 10%, or at least about 15%, or at least about 20%. For example, the velocity of detonation of the W/O emulsion explosive may be improved by an amount ranging from about 5% to about 25%, or from about 10% to about 20%.

The present invention can make use of graphene oxide having a wide range of particle sizes. For example, the average or median largest dimension of the graphene oxide can range from 0.1 μm to about 5 mm, for instance, in some embodiments about 0.5 μm to about 5 mm.

The present invention can be performed using varying amounts of graphene oxide. For example, the W/O emulsion explosive may comprise from about 0.007 wt % to about 5 wt % graphene oxide, for instance, in some embodiments about 0.1 wt % to about 1 wt % grapheme oxide.

In certain embodiments in which the graphene oxide is incorporated into the W/O emulsion explosive during or as part of an emulsification stage of preparing the W/O emulsion explosive, it may be desirable to use graphene oxide in an amount of from about 0.007 wt % to about 0.1 wt %

Where the graphene oxide is incorporated into the W/O emulsion explosive after an emulsification stage of preparing the W/O emulsion explosive, such as when graphene oxide is incorporated into a pre-formulated W/O emulsion explosive as an additive thereto, it may be desirable to use graphene oxide having an average or median largest dimension ranging up to about 5 mm.

In certain embodiments in which the graphene oxide is incorporated into the W/O emulsion explosive after an emulsification stage of preparing the W/O emulsion explosive, it may be desirable to use graphene oxide in an amount of from about 0.1 wt % to about 5 wt %.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavour to which this specification relates.

Aspects and embodiments of the invention are described in more detail below.

### BRIEF DESCRIPTION OF THE DRAWINGS

Certain embodiments of the invention where hereinafter be described with reference to the following non-limiting drawings in which:

FIG. 1(a) shows deconvoluted Cls XPS spectra of pristine GO. The spectra was fitted to different peak intensities corresponding to sp² Carbon and Carboxyl functional group (—COOH) and values are consistent with literatures. (b) shows deconvoluted Cls spectra of partially reduced GO. The reduction in the intensities of carbonyl functional groups can be attributed to the partial thermal reduction of the pristine GO. (c) shows the FTIR spectra which re-confirms the partial reduction via reduced intensity of the carbonyl functional group at ˜1620 cm⁻¹. (d) shows the Raman spectra of Graphite, GO and prGO. With oxidation, defect density increases leading a D-band corresponding to sp3 carbon and broader G-band shifting to higher frequencies as a consequence of amorphization. Partial thermal reduction induces rupturing of GO sheets at high temp, inducing disorder and broad G-band along with a shift in lower frequencies due to dominance of sp2 carbon;

FIG. 2 shows contact angle of GO and prGO with the canola oil and water. (a) GO and oil (b) GO and water (c) prGO and Oil and (d) prGO and water;

FIG. 3 (a) shows oil droplet inside water continuous phase with hydrophilic GO at the interface. (b) Water droplet inside oil continuous with less hydrophilic partially reduced GO at the interface. Hydrophilic groups wet the water phase while hydrophobic domains wet the oil phase. With less hydrophilicity, hydrophobic domains in reduced GO will wet the oil phase forming oil as the continuous phase;

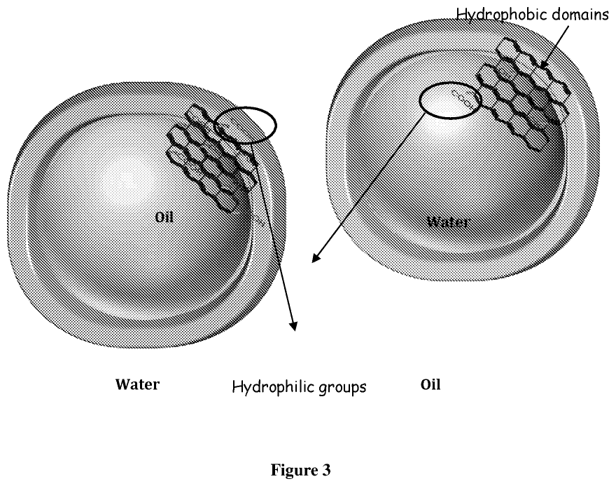

FIG. 4 shows photographs of a GO dispersion, prGO dispersion and W/O emulsion;

FIG. 5 shows W/O emulsion with different graphene derivatives viz. pristine GO, partially reduced and fully reduced. The reduction of GO was varied and controlled from no reduction to partial to fully reduced GO. After the preparation confocal imaging of the same was immediately observed;

FIG. 6 shows W/O emulsion with different graphene derivatives viz. pristine GO, partially reduced and fully reduced. The reduction of GO was varied and controlled from no reduction to partial to fully reduced GO. After the preparation confocal imaging of the same was immediately observed;

FIG. 7 shows confocal imaging of w/o emulsion with different continuous (oil) phase volume fraction. The oil composition of emulsion was varied at the synthesis step. With decrease in the oil phase in the emulsion the water droplets will try to approach each other and ultimately collapse and coalesce, giving no emulsion at very low oil volume;

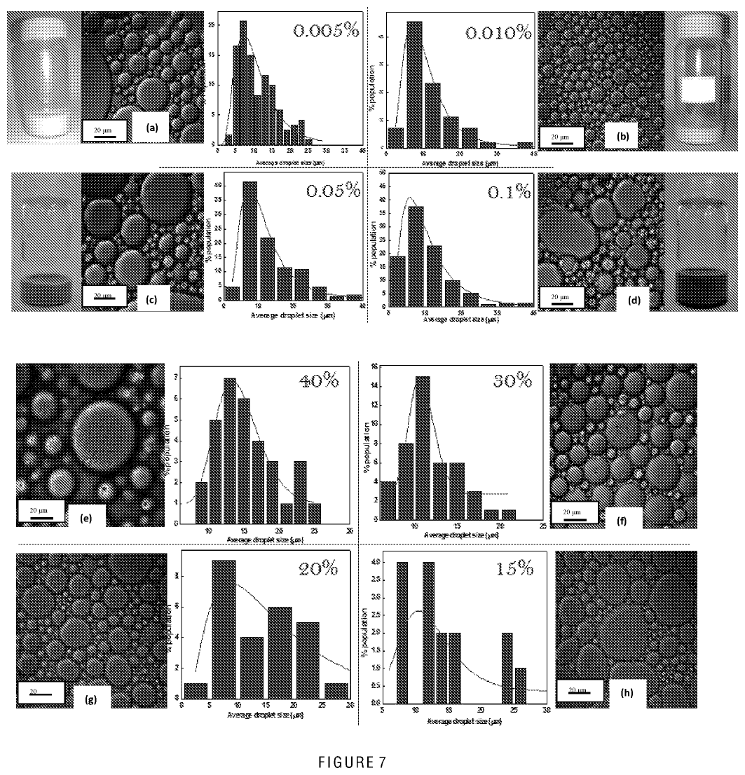

FIG. 8 shows rheological properties of w/o emulsion. The emulsion was analyzed for (a) and (b) amplitude sweep, (c) and (d) frequency sweep. These properties were compared with that of an o/w emulsion prepared using pristine GO;

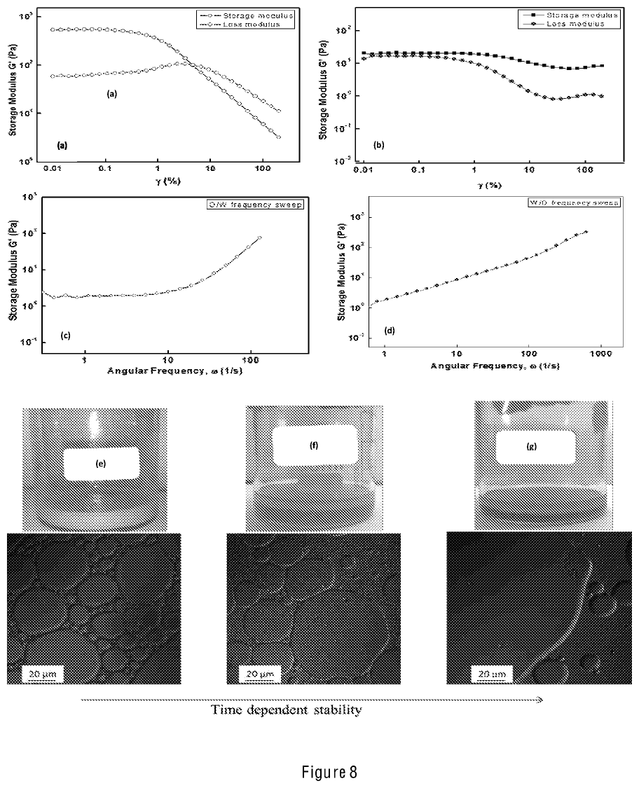

FIG. 9 shows AC electrical conductivity of the prGO stabilized W/O emulsion with time. There is no change in the conductivity in the initial days of the synthesis. From day 4 the prGO coated water droplets starts settling with evolution of oil phase;

FIG. 10 shows decay in normalized droplet size distribution of the W/O emulsion with time. The broader droplet size distribution shows that the coalescence is the prevailing mechanism in the destabilization of prGO stabilized W/O emulsion;

FIG. 11 shows evolution of Sauter mean diameter with time. Due to coalescence, the mean diameter of the prGO stabilized emulsion and the phases separate by the 20th day;

FIG. 12 shows confocal microscopy images and corresponding droplet size distribution of the W/O emulsions synthesized using (a) 3.0 wt %, (b) 0.3 wt % and (c) 0.15 wt % concentration of E-476 emulsifier. The GO concentration was kept constant at 0.007 wt %;

FIG. 13 shows oscillatory shear measurements in the linear viscoelastic regime (L-V-E). Amplitude sweep (strain sweep) plots of emulsion with E-476 concentration (a) 3.0 wt % (b) 0.3 wt % and (c) 0.15 wt %. Frequency dependence of elastic modulus of emulsion with E-476 concentration 3.0 wt %, 0.3 wt % and 0.15 wt % is represented in (d), (e) and (f) respectively;

FIG. 14 shows confocal microscopy images and corresponding droplet size distribution of the W/O emulsions with GO concentration (a) 0.007 wt %, (b) 0.014 wt %, (c) 0.025 wt % and (d) 0.052 wt %. The E-476 concentration was kept constant at 3.0 wt %;

FIG. 15 shows oscillatory shear measurements in the linear viscoelastic regime (L-V-E). Amplitude sweep (strain sweep) plots of emulsion with GO concentration (a) 0.007 wt % (b) 0.014 wt %, (c) 0.025 wt % and (d) 0.052 wt %. Frequency dependence of elastic modulus of emulsion with E-476 concentration 0.007 wt % 0.014 wt %, 0.025 wt % and 0.052 wt % is represented in (e), (f), (g) and (h) respectively;

FIG. 16 shows confocal microscopy images and corresponding droplet size distribution of the W/O emulsions with (a) 25 wt %, (b) 30 wt % and (c) 35 wt % concentration of Ammonium sulphate salt. The GO concentration and the E-476 concentration was kept constant at 0.007 wt % and 3.0 wt % respectively;

FIG. 17 shows flow properties of the emulsion with respect to (a) E-476 concentration and (b) GO concentration;

FIG. 18 shows thermal imaging of (a) W/O emulsion without GO and (b) W/O emulsion with GO;

FIG. 19 shows (a) variation in the thermal conductivity of the emulsion with respect to the increase in the GO concentration (b) Enhancement in the thermal conductivity of the emulsion with increase in the GO concentration;

FIG. 20 shows FITR of the ethylene diamine functionalized GO;

FIG. 21 shows pristine Oil, GO mixed in Oil and fGO dispersion in Oil;

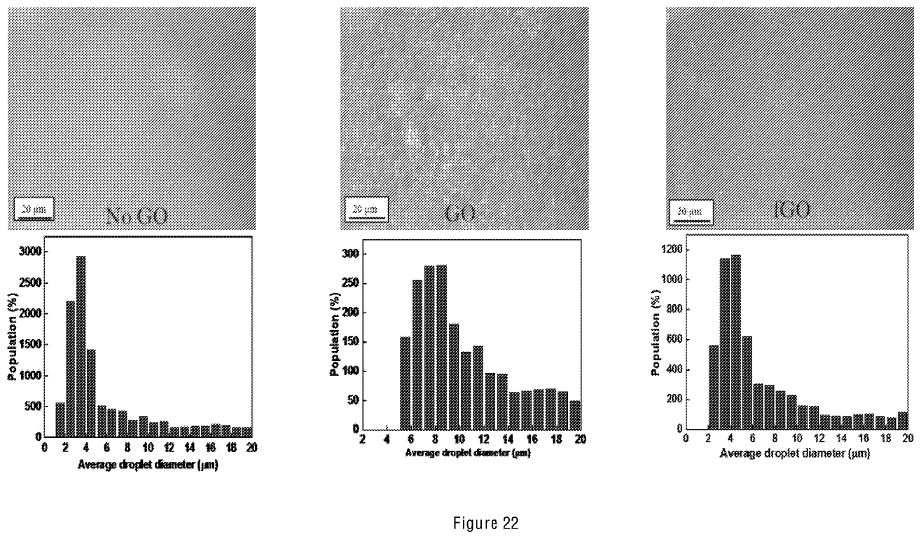

FIG. 22 shows confocal microscopy images and corresponding droplet size distribution of the W/O emulsions with (a) No GO (b) 0.014 wt % GO and (c) 0.1 wt % fGO;

FIG. 23 shows oscillatory shear measurements in the linear viscoelastic regime (L-V-E). Amplitude sweep (strain sweep) plots of emulsion with GO concentration (a) No GO (b) 0.014 wt % GO and (c) 0.1 wt % fGO;

FIG. 24 shows the percentage enhancement in the thermal conductivity of the GO incorporated W/O emulsion with respect to the increase in the GO concentration. At very low concentration of GO, the enhancement is of the order of 2% only. With increase in the concentration, the enhancement is greater or more significant. At high(er) concentration, the enhancement is about 7%, which is highest with maximum GO concentration that can be used to prepare emulsion;

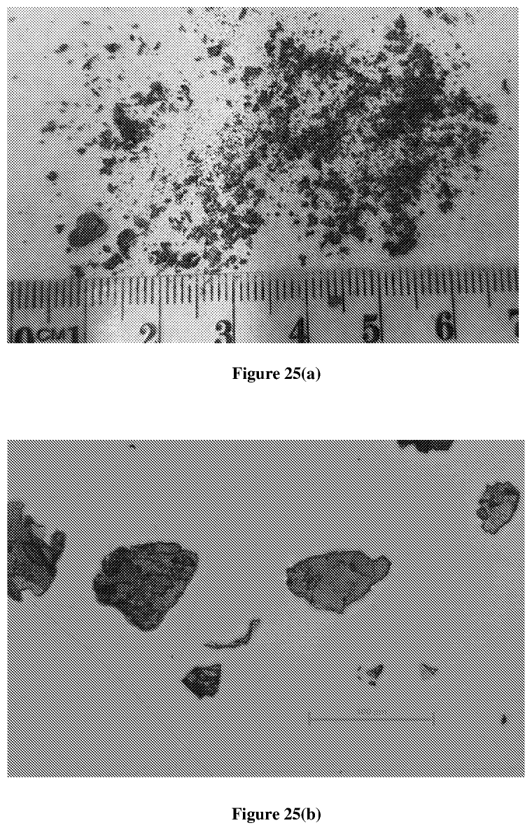

FIGS. 25(a), (b), and (c) show images of GO particles after pulse grinding.

FIG. 26 shows a VoD trace from Example 4 of ANE Gold DC, with no GO, density 0.95 g/cc;

FIG. 27 shows a VoD trace from Example 4 of ANE Gold DC, with 0.25% w/w GO, density 0.95 g/cc; and

FIG. 28 shows Differential Scanning calorimetry (DSC) results from Example 5, corresponding to a commercially available W/O emulsion explosive product without GO incorporated and blended therein as an additive, and with GO incorporated and blended therein as an additive at 5 wt % GO.

### DETAILED DESCRIPTION OF THE INVENTION

### Overview of Graphene Oxide and Emulsions

With respect to emulsions, a surfactant has an amphiphilic nature. Graphene oxide, which can present as an oxidized single sheet of graphite, has oxygen containing hydrophilic edges and hydrophobic graphitic patches at its basal plane, making it an amphiphile. Graphene oxide can act as an emulsifier or surfactant and stabilize oil-water emulsions. In addition to stability, graphene oxide provides high thermal conductivity to an emulsion because of the presence of an oxygen group which increases phonon scattering. As disclosed herein, graphene oxide can be a useful surfactant in emulsion explosives.

Partially oxidized graphene sheets possess hydrophilic surface groups such as carboxylic acid and epoxies, but also exhibit hydrophobicity from the remaining sp² domains. These nanosheets can be engineered to remain at the interface of hydrophobic/hydrophilic liquids like oil-water and exhibit surfactant-like properties and may lead to the formation of emulsions. How the microstructure of the emulsion evolves can depend upon conditions such as concentration of the graphene sheets, degree of oxidation, pH, ionic concentration and hydrophobicity of the oil phase. The evolution of the microstructure can be indicated by the rheological measurement of emulsion. The high thermal conductivity of graphene oxide can be useful emulsion explosives or emulsion explosive compositions, e.g., in oil-water emulsion explosive compositions, or other compositions where fluids are useful or used for heat exchange process.

The majority of industries that use emulsions, such as the food, pharmaceutical, cosmetics, petroleum product, and mining industries, utilize highly concentrated emulsions in various applications in a variety of applications or technical fields. Especially the mining industries use highly concentrated emulsions to a great extent. Keeping that in mind, a highly concentrated emulsion explosive composition having high thermal conductivity, e.g., which can be provided by way of the use of graphene oxide as an emulsifier or surfactant therein, offers new possibilities in emulsion explosives applications, including for purpose of affecting, managing, or controlling heat exchange and associated processes.

Use of graphene oxide as disclosed here can advantageously enhance the thermal conductivity of emulsion explosives. Such use can also enhance emulsion explosive detonation performance as well as stabilize emulsion explosives.

The components or ingredients used in an emulsion explosive are mainly an oil mixture and water, with added oxidizer ammonium nitrate. Emulsifier is added along with the oil mixtures such as sorbitan mono oleate. The commonly used sources of hot spots in emulsion explosives are voids, which can include or be gas bubbles, glass micro balloons (GMB), and/or small hollow microspheres of resinous materials such as phenol-formaldehyde and urea formaldehyde.

A drawback of using the voids is that the explosive density is reduced with consequent reduction in bulk energy. For instance, the condensed phase of most emulsion explosive premix, before gassing, has a density of about 1.4 g/cm³. However, in practice, the emulsion explosives produced for small diameter applications have densities less than 1.1-1.2 g/cm³ or a reduction of 15-20%.

The conveyance or transportation of an emulsion explosive composition across significant or long(er) distances, as well as the storage of an emulsion explosive composition over a significant period of time, requires long term stability of an oil-water emulsion that forms the basis of the emulsion explosive composition. Thus, a need exists for an emulsifier or surfactant that can stabilize the droplets for a significant, long, or very long duration. Graphene oxide, which has high aspect ratio and is an amphiphile with atomic level colloidal effect, adsorbs to the droplets in an emulsion explosive composition at very low concentration. Graphene oxide can enhance the stability of or make a stable emulsion explosive composition, which can last for months without any physical or chemical changes.

Another emulsion explosive composition parameter for which graphene oxide is relevant is the velocity of detonation (VOD). The typical VOD of emulsion explosives is about 5 km/s, and it varies with the composition of the emulsion. The high thermal conductivity of graphene oxide can result in or generate high VOD due to high phonon transfer. Hence, due to its high thermal conductivity, graphene oxide can be utilized to generate or aid the generation of hot spots via heat transfer from the hot reaction products to the material in the pre-reaction zone. The heat transferred by the graphene oxide heats up the emulsion explosive around the graphene oxide sheets, i.e. graphene oxide forms the hot spots by a heat conduction mechanism. Thus, the addition of graphene oxide can, in effect, increase the number of hot spots, which leads to enhanced detonation performance. Here, the effective number of hot spots can be increased without compromising the density of the system. This can improve the VOD of an emulsion explosive composition, with less reliance on void generated hot spots. Therefore, the graphene oxide (e.g., graphene oxide sheets), if incorporated uniformly and efficiently into the emulsion matrix, can improve the detonation performance of emulsion explosives.

An emulsion is a class of colloids and can be defined as the dispersion of one liquid into another; both are immiscible when combined. In an emulsion, one liquid tends to remain in the other liquid in the form of droplets in presence of one or more (surface-active agents) surfactants. The liquid, which is in the form of droplets, is called the dispersed phase (or internal phase); the liquid in which it is dispersed is called the continuous phase (or external phase).

Emulsions are generally made up of two immiscible liquid phases for which the surface tension is nonzero. They involve other hydrophilic-like or lipophilic-like fluids in the presence of suitable surface-active species, each phase being possibly composed of numerous components.

Emulsions are generally formed when two immiscible liquids are subjected to mechanical energy such as when a high shear force is applied or when they are ultrasonicated. When an external force such as a high shear is applied to a two-phase liquid, one phase fragments in the form of droplets and gets dispersed into the other phase. Being a class of colloids, an emulsion also exhibits the same behaviour as that of a colloid; one is Brownian motion of dispersed droplets and another is coalescence which leads to emulsion destruction. Depending on the amount of droplets present, the volume fraction of droplets ranges from zero to almost one. The emulsion is then described as being ‘dilute’ or a ‘highly concentrated emulsion’. Similarly, if the emulsion is strongly diluted, the droplets exhibit the Brownian motion; from then on the emulsion behaves as a viscous Newtonian fluid. On the other hand, if the emulsion is concentrated at, for example, 64% of dispersed droplets then the emulsion behaves as a visco-elastic solid.

An important parameter used to describe emulsions is the volume fraction, 0. It is the ratio of volume of the inner to the outer phase. For example, for spherical droplets of radius ‘a’, the volume fraction is given by the number density, ‘n’ times the spherical volume, ø=4π a³n/3. Many physical properties of emulsions can be characterised using volume fraction 0.

The emulsion is stabilised or in other words the droplets are retained using a third component known as an emulsifying agent or emulsifier. An emulsifier can be a surfactant (surface-active reagent), macromolecules or a finely-divided solid. The selection of the emulsifier is of utmost importance for the formation of a stable emulsion. The choice of emulsifier affects the type of the emulsion formed, its long-term stability and the rheology of the emulsion.

Pickering emulsions are solid-stabilized emulsions where solid particles minimize the interfacial energies of two immiscible liquids by their amphiphilic nature. Depending on the amount of hydrophilic groups with respect hydrophobic groups, the emulsion can be oil-in-water or water- in-oil. This is characterized by the hydrophilic to lipophilic (or hydrophobic) balance measurement abbreviated as HLB. The HLB number is a relative percentage of hydrophilic to lipohilic (hydrophobic) groups in the surfactant molecule, and value of the HLB number is between 0 and 20. These are assigned first on a one-dimensional scale of surfactant action after which, each surfactant is rated according to this scale.

Graphene oxide (GO), the oxygenated derivative of graphene, is predicted to behave as a surfactant stabilizing water, oil phases. This analysis is based on the fact that GO is an amphiphile with hydrophilic oxygen functionalized edges and hydrophobic graphitic patches on the basal plane. Until now, most reports have focused on producing oil-in-water (o/w) emulsion using graphene oxide (GO) as a surfactant. While there are a few papers which reports water-in-oil (w/o) emulsion using GO as a surfactant, the focus of such papers is on producing unique structured GO like hollow or nano spheres. The preparation of w/o emulsion is based on alkaline dispersion medium of GO. Additionally, there are reports which mention the presence of double emulsions like w/o/w emulsions along with the o/w emulsions produced.

Fully oxidized graphene oxide is electrically insulating because of disrupted sp² bonding networks. But in reality, graphene oxide conductivity varies from insulator to semiconductor depending on the extent of oxidation and applied electric field. The electrical conductivity can be restored to greater amount by restoring π-network, achieved by reducing graphene oxide.

Graphene can be reduced chemically, thermally and electrochemically reduced depending on environment in which it is reduced to remove the oxygen functionality in its structure. Chemically, graphene oxide can be reduced by using strong reducing agents such as hydrazine monohydrate. Graphene oxide can also be reduced by heating it at very high temperature in inert atmosphere. The electrochemical reduction involves the transfer of reduced graphene on one of the electrodes while oxygen groups retain in the electrolyte. The electrochemical reduction yields high carbon- to-oxygen ratio which will give high electrical conductivity compared to other two methods. These days there are several other methods which are reported to reduce graphene oxide effectively like green tea reduction, biochemical reduction and many more.

The mechanical properties of graphene oxide are less pronounced compared to pristine graphene having good elastic properties and breaking strength. This is because of the presence of defects and distorted layers in graphene oxide assembly. These defects and graphite impurities direct the flow of stress transfer and breaking strength decreases. However, with possible functionalization and self assembly of graphene oxide sheets can improve the mechanical properties of graphene oxide to a greater extent.

The nanometer size of graphene oxide makes it optically transparent; however, the transparency decreases with the increase in number of stacks. A single layer of graphene is optically transparent with 97.7% constant transparency in the visible range. On the other hand, a single layer of graphene oxide is less transparent because of the presence of oxygen groups and defects causing light absorption.

The presence of hydrophilic functional groups makes it a soft material and allows its dispersion into solvents like water. The dispersion of graphene oxide in water acts as a solvent to dissolve other carbon compounds not soluble in water by the presence of graphitic domain which makes π-bonding with other carbon materials. Also, the high aspect ratio of graphene oxide allows orientational ordering making it a liquid crystal. The amphiphile structure of graphene oxide not only allows further possibilities for dissolving carbonaceous material and compounding them but also allows it to act as a surfactant to stay at the interface of organic-inorganic liquid mixture.

The thermal conductivity of graphene oxide is higher compared to that of a pure graphene. The reason is the presence of defects and oxygen functional groups provides extra phonons for the transfer of thermal energy. The thermal conductivity of graphene oxide is mostly dominated by the phonon transport rather than electron transport as the carrier density is very low.

When thermal conductivity of graphene is compared, the in-plane thermal conductivity of graphene at room temperature is among the highest of any known material, about 2000-4000 W m⁻¹ K⁻¹ for freely suspended samples. Functionalization of graphene will introduce more phonons and increase in thermal conductivity. This is the case when thermal conductivity of graphene oxide is considered in comparison to graphene.

In graphene oxide, the carrier density is very low as compared to graphene. As a result, the electronic contribution to thermal conductivity is negligible. So for graphene oxide one can say that the thermal conductivity is dominated by phonon transport, namely diffusive conduction rather than ballistic conduction for graphene.

A single layer graphene has high thermal conductivity than few layer graphene. The introduction of one or more layers will reduce the thermal conductivity significantly and sometimes approaches to that of bulk graphite. The effect of interlayer spacing on thermal conductivity is also pronounced. This combination of number of layers and interlayer spacing will decide the change in thermal conductivity.

Increase in interlayer spacing and presence of oxygen groups enhances phonon scattering. The increase in thermal conductivity of graphene oxide can be attributed to the increase in the interlayer coupling due to covalent interactions provided by oxygen atoms.

Disclosed herein is the synthesis and properties of water-in-oil emulsions, in particular emulsion explosives or emulsion explosive compositions, using partially reduced GO, and the effects of parameters such as pH, temperature, and salt concentration on the stability of the emulsion explosive composition. Some embodiments of emulsion explosive compositions in accordance with the present invention provide a highly concentrated emulsion having volume fraction of the aqueous phase greater than 0.74. Characterizations like XPS, FTIR and Raman were performed for the GO. Additionally, droplet size analysis through Confocal microscopy image processing was done to characterize the emulsions and determine their stability. In various embodiments, a W/O emulsion in accordance with the present disclosure is metastable, and can be stable for 10-20 days from the day of its formation. The de-stabilization pattern of representative W/O emulsions was observed and analyzed using time-dependent droplet size distribution. The de-stabilization data was fitted with Coalescence and Ostwald ripening models and further explained using Coalescence dynamics. Further, to improve the stability of the W/O emulsion, PIBSA-based emulsifier was used along with GO. Stability analysis of the W/O emulsion synthesized using the emulsifier and GO indicated enhanced stability with finer droplet size distribution and improved rheological properties in comparison to that of the emulsion with only GO. Particular embodiments in accordance with the present disclosure also exploited the good thermal properties of GO. An emulsion explosive composition prepared with GO in accordance with an embodiment of the present disclosure will have better thermal conductivity (e.g., by up to 13.5%, or between 2.5%-13.5%, or between 5%-13.5%, or 7% up to 13.5% depending upon embodiment details) than an otherwise equivalent emulsion explosive composition that lacks GO.

### Transient Stability of W/O Emulsion Using Partially Reduced Graphene Oxide as the Emulsifier

Graphene Oxide (GO), the oxygen-derivatized Graphene, has been an interest of study as a surfactant from last few years. Variety of reports have studied on different aspects of GO as a surfactant, from parameter dependent stabilization with parameters like pH, oil volume fraction, salt concentration etc to the application of the GO stabilized emulsion as a template for hollow or porous microstructures.

Most of these reports were focused on the stabilization of an oil-in-water (O/W) emulsion, e.g., because GO being more hydrophilic disperses well in water. Following Bancroft's rule (B. P. Binks, Modern Aspects of Emulsion Science, 1997), GO stabilizes oil droplets in the water continuous phase, making an O/W emulsion. Out of these reports, the studies have been limited to the understanding microscopy, rheology and supercapacitor properties of the O/W emulsion stabilized by GO.

There are very few reports on the preparation of water-in-oil (W/O) emulsion. The formation of hollow GO via W/O emulsion route has been reported. The underlying mechanism has been proposed as being the self-assembly of GO sheets due to the flocculation at basic pH, preparation of hollow spheres for Li-ion applications was the main focus. A W/O emulsion has also been synthesized by functionalizing GO using CTAB. CTAB generates long hydrogen chain on GO, making it more hydrophobic and it disperses in oil making high internal phase emulsion (HIPE). However, in these works the focus was limited only to certain after applications of the synthesized W/O emulsion. The colloidal aspects of the W/O emulsion stabilized by GO, still remained untouched viz. the effect of parameters like oil phase volume fraction, GO concentration, and extent of oxidation in GO, on the maximum stable emulsion volume. In addition, there is no specific study to date on the stabilization of W/O emulsion by reduction of GO and change in the Hydrophilic-to-Lipophilic Balance (HLB).

In some embodiments the invention is directed to the synthesis and properties of W/O emulsion stabilized using partially reduced GO (prGO), and the effect(s) of parameters like prGO concentration, extent of reduction of GO, and oil phase volume fraction. The W/O emulsion stabilized by prGO attains its maximum stability by optimizing the above parameters, and in various embodiments it destabilizes within 20 days, indicating it is a metastable emulsion. The cause of the metastability was carefully analyzed and explained using microscopy, rheology and electrical conductivity as settling followed by coalescence. Settling arises due to non-dispersion of prGO in oil which follows coalescence by collision of nearby droplets. The study results herein use a simple approach of partial reduction to stabilize W/O, and extends the effect of parameters on the emulsion stability, both of which are not previously studied.

Details relating to the stability of W/O emulsion prepared by using partially reduced Graphene Oxide are outlined in Example 1. With partial reduction, more hydrophobic domains exposed to the hydrocarbon Oil phase which changes the Hydrophillic-to-Lipophillic Balance (HLB) and ultimately the wettability of the Graphene Oxide. This enables the synthesis of a W/O emulsion instead of O/W emulsion by pristine Graphene Oxide. The stability was monitored with the change in the parameters like extent of reduction, concentration of Graphene Oxide and the continuous phase volume fraction. Further, the synthesized W/O emulsion is metastable in behavior with stability to or until 20 days from the day of its synthesis. The instability mechanism was tested using time dependent electrical conductivity and droplet size distribution of confocal imaging. The non-dispersion of partially reduced Graphene Oxide in the Oil phase leads to sedimentation of prGO coated water droplets. The sedimentation is followed by the Coalescence of the droplets due to insufficient surface coverage because of compression.

### Thermal Conductivity Enhancement of the W/O Emulsion by Graphene Oxide

Thermal conductivity enhancement by Graphene oxide (GO) incorporation in the water-in-oil (W/O) can be useful in applications or technologies that utilize or require efficient heat transfer like emulsion explosives. Herein, W/O emulsion is synthesized using PIBSA-based emulsifier (E-476) along with GO by dispersing GO in the aqueous phase and thermal conductivity of the resultant emulsion was explored and compared with that of the emulsion prepared without using the GO. It was found that GO being an amphiphile competes with the emulsifier E-476 to get to the water/oil interface. This makes it inhibit the emulsifier action, increase the refinement time, widens the droplet size distribution. The critical cross over point where elastic-to-viscous transition occurs decreases with increase in GO concentration and increases with the increase in E-476 concentration. While the GO at the interface inhibits the emulsifier action, it increases the thermal conductivity of the emulsion. An emulsion with GO showed higher thermal conductivity than the emulsion without GO. This increase can be attributed to the high thermal conductivity of the GO. The thermal conductivity enhancement was verified by IR images from a thermal camera. The rise in thermal conductivity of the emulsion can also be attributed to the GO being at the interface.

As described in Example 2, highly concentrated W/O emulsions were prepared with GO and E-476 emulsifier. Stability as well as rheology of the emulsion were examined using confocal imaging and oscillatory measurements along with varying the E-476 and GO concentration. It was observed that GO and E-476 in the emulsion compete to go to interface and minimize the interfacial energy of the aqueous phase: fuel blend system. This makes the emulsification refining of droplets difficult leading to the formation of large droplets and introduces polydispersity. GO being an amphiphile, is a strong surfactant to stabilize water-oil interface. The inhibition action of GO deteriorates the rheological properties by making the emulsion flow at low stress-strain values. This also indicates the presence of the GO at the interface. Though GO affects the stability and the rheology, it performs well in increasing the thermal conductivity of the emulsion. GO at the interface enhances the thermal conductivity of the emulsion up to 7% at the maximum concentration of GO that can be employed in the emulsion.

### Amine Functionalization of GO and Incorporation in Emulsion Explosive

Functionalization chemistry of the Graphene Oxide (GO) is widely known. A variety of reports have studied on different aspects of GO as a surfactant, from parameter dependent stabilization with parameters like pH, oil volume fraction, salt concentration etc to the application of the GO stabilized emulsion as a template for hollow or porous microstructures.

Most of these reports were focused on the stabilization of an oil-in-water (O/W) emulsion. GO being more hydrophilic disperses well in water. Following Bancroft's rule, GO stabilizes oil drops in the water continuous phase making an O/W emulsion. Out of these, studies have been limited to the understanding microscopy, rheology and supercapacitor properties of the O/W emulsion stabilized by GO.

There are very few reports on the preparation of water-in-oil (W/O) emulsion using GO. The formation of hollow GO via W/O emulsion route has been reported. The underlying mechanism has been proposed to be the self-assembly of GO sheets due to the flocculation at basic pH, preparation of hollow spheres for Li-ion technology was the main focus. A W/O emulsion has also been synthesized by functionalizing GO using CTAB. CTAB generates long hydrogen chain on GO, making it more hydrophobic and it disperses in oil making high internal phase emulsion (HIPE). However, in these works the focus was limited only to certain after applications of the synthesized W/O emulsion. The colloidal aspects of the W/O emulsion stabilized by GO, is still untouched viz. the effect of parameters like oil phase volume fraction, GO concentration and extent of oxidation in GO, on the maximum stable emulsion volume. In addition, there has been no specific study on the stabilization of W/O emulsion by reduction of GO and change the Hydrophilic-to-Lipophilic Balance (HLB).

Some embodiments of the invention focus on the synthesis and properties of W/O emulsion stabilized using partially reduced GO (prGO), extending to effecting parameters such as prGO concentration, extent of reduction of GO and oil phase volume fraction. The W/O emulsion stabilized by prGO attains its maximum stability by optimizing the above parameters, and it destabilizes within 20 days indicating it is a metastable emulsion. The cause of the metastability was carefully analyzed and explained using microscopy, rheology and electrical conductivity as the settling followed by coalescence. Settling arises due to non-dispersion of prGO in oil which follows coalescence by collision of nearby droplets. Results disclosed herein use a simple approach of partial reduction to stabilize W/O and extend the effect of parameters on the emulsion stability, both of which have not been previously studied.

Highly concentrated W/O emulsions were prepared with fGO and E-476 emulsifier in Example 3. Stability as well as rheology of the emulsion were examined using confocal imaging and oscillatory measurements along with varying the E-476 and fGO concentration. It was observed that fGO and E-476 in the emulsion competes to go to interface and minimize the interfacial energy of the aqueous phase: fuel blend system. This makes the emulsification refining of droplets difficult leading to the formation of large droplets and introduces polydispersity. fGO being an amphiphile, is a strong surfactant to stabilize water-oil interface. The inhibition action of fGO deteriorates the rheological properties by making the emulsion flow at low stress-strain values. This also indicates the presence of the fGO at the interface. Though fGO affects the stability and the rheology, it performs well in increasing the thermal conductivity of the emulsion. fGO at the interface enhances the thermal conductivity of the emulsion up to 13.5% at the maximum concentration of fGO that can be employed in the emulsion.

The present invention will herein after be described with reference to the following non-limiting examples.

### EXAMPLES

### Example 1

### Materials and Methods

Canola oil was obtained from Orica Mining Services Pty. Ltd., Australia. Being a proprietary information, complete chemical structural information is not provided by the supplier. The graphite flakes was purchased from Sigma-Aldrich (99.95% purity).

### Synthesis of Graphene Oxide and Partially Reduced Graphene Oxide

GO was synthesized using Hummers' method. In this method, 2.0 gm of graphite flakes (Sigma-Aldrich 99.95%) and 1.0 gm of the salt NaNO₃ (Merck 98.5%) were mixed with 46 ml of concentrated H₂SO₄ (Merck 98%) in a 500 ml beaker and stirred on ice bath for 15 min. The temperature of the ice bath was maintained at 0° C. Then, 6.0 gm of KMnO₄ (Merck 98.5%) was added maintaining the reaction temperature at 20° C. with continuous stirring. The stirring was continued for 2 h at 35° C. The mixture turned into black gel type slurry eventually during the stirring. Exactly, 100 ml of DI water (18.2 MX-cm) was slowly added leading to huge exothermic reaction and the temperature rose to 98° C. The reaction temperature was kept at 98 ° C. for 30 min. Now, the bath was removed and the mixture was allowed to cool to room temperature. After cooling, around 12 ml of H₂O₂ (Merck 30% purified) was added until the color of the mixture changed to golden yellow and more of DI water was added. The mixture was centrifuged at 4000 rpm for 2 h and supernatants were decanted away. The residual material was washed 3-4 times with 10% HCl to remove the metal ions and finally with DI water till it attains a pH value between around 5. The dispersion was filtered using whatmann filter and solid was dried in vacuum for 4h at 50° C. and finally a brown colored GO powder was produced.

Thermal reduction: As-synthesized GO was dispersed using a probe sonicator for 5 minutes and centrifuged at 12000 rpm for 15 min. The supernatants were decanted away. The GO dispersion was filtered in a vacuum filter using Cellulose Acetate filter paper. The filtrate along with the filter paper was placed in a petry dish containing commercial grade Acetone. Acetone dissolves the filter paper and GO filtrate in form of a paper was separated. This GO paper was placed on a Teflon sheet in a petry dish and heated in a vacuum oven at 300° C. temp for 24 hours. For emulsion preparation, this GO paper was used.

### Preparation of Water-in-Oil Emulsion Using Graphene Oxide

GO paper was dispersed in 8 ml DI water with a concentration of 1 mg/ml by ultrasonicating for 30 min. The pH of GO emulsion is maintained at 6. This dispersion was heated to 65 ° C. temp on a water bath. 2 ml of Canola oil is taken in a 100 ml beaker and heated to 90 ° C. temp on a hot plate. Hot Canola oil was stirred at 600 rpm using a high shear mixer and GO dispersion was added to it slowly. The addition was done in such a way that entire 8 ml of GO was fully added within 1 minute. The stirring was continued for next 2 minutes. Further, the shearing speed was increased to 1400 rpm and the mixer was stirred for next 2 minutes. At the end of the stirring, yellowish white paste like emulsion is obtained.

### Characterization

The as-synthesized graphene oxide and partially reduced powder was dispersed in DI water and ultrasonicated for 30 minutes to get uniform dispersion. For Raman spectroscopic analysis, XPS and FTIR (on KBr pellet); the dispersion was drop casted on a glass slide, heated at 50° C. temperature in vacuum for 4 hours and was used for the analysis.

### Raman Spectroscopic Analysis

Raman spectroscopic analysis was performed using a HR 800 micro-Raman (HORIBA Jobin Yovon, France) on as received. The scanning range was from 1000 to 1800 cm⁻¹ with incident laser excitation wavelength of 514 nm.

### Fourier Transform Infrared Spectroscopy (FTIR)

FTIR investigations were carried out on 3000 Hyperion Microscope with Vertex 80 FTIR System. The samples were prepared by depositing the dispersion on KBr pellets and drying the pellets in vacuum.

### X-Ray Photoelectron Spectroscopy (XPS)

The XPS analysis was performed using Twin anode (MgKα/ZrLα) 300 W and Microfocused monochromatic concentric hemispherical analyzer (CHA). The drop casted samples of both graphene oxide and reduced graphene oxide were used to obtain the raw data which was further deconvoluted to fit different peaks corresponding to different functional groups.

### Scanning Electron Microscopy in Cryo-Mode

The droplet fracture morphology was investigated using FEG-SEM (JSM-7600F) and cryo preparation system (PP3000T). The cryo preparation system features Variable temperature conduction cooled specimen stage (−185° C. to 50° C.) and Gas-cooled nitrogen cold stage assembly (−192° C. to 50° C.). About 2-3 drops of emulsion sample was placed on a copper crucible and was freezed using liquid nitrogen. The freezed sample was introduced into the SEM chamber and fractured using an attached knife in the chamber. Finally, the fractured sample was transferred to the cooled specimen stage to observe the microstructure.

### Transmission Electron Microscopy in Cryo-Mode

prGO encapsulation on the water droplets was investigated using JEM 2100 ultra HRTEM, a cryo mode facility with cryo specimen holder. The sample was prepared in cryo mode. For this, a drop of emulsion sample was cast on a holey carbon grid and was plunge-frozen using cryo plunger (Gatan Inc.). Frozen-hydrated specimens were transferred to TEM via cryo transfer unit under liquid nitrogen. The frozen samples were imaged using a FEI Vitrobot equipped with a LaB6 filament operating at 200 kV.

### Fluorescence Imaging

The fluorescence imaging was carried out using Olympus IX 81 (combined with FV-500) confocal laser scanning microscope using the emulsion having prGO, mildly functionalized with Fluorescein isothiocyanate (FITC). FITC was loaded on prGO by sonication of FITC solution (0.05 wt %, 10 ml) in DI water with prGO dispersion (0.5 mg/ml, 10 ml) followed by overnight stirring in dark. Unreacted FITC was removed by centrifugation at 6000 rpm for 2 hrs. The obtained FITC functionalized prGO was further used for W/O emulsion preparation. The sample preparation was done using the similar approach as of the confocal microscopy analysis. The images were taken in the fluorescence mode by setting the absorbance around 519 nm wavelength corresponding to the excitation wavelength of the FITC.

### Confocal Laser Scanning Microscopic Analysis

Confocal micrographs were obtained using Olympus IX 81 (combined with FV-500) confocal laser scanning microscope at magnification of 100×A drop of the emulsion was placed on a glass slide and immediately covered with a covering slide to get a thin layer of emulsion between the glass slides. The samples could cool prior to observing and photographing under the microscope. A drop of type-F immersion oil (n=1.518 at 23° C.) was applied on the lens to improve the resolution. The microscopic analysis was carried out at within 24 hours of emulsion preparation to prevent improper as the de-stabilization starts after preparation. The diameter of individual droplets in the emulsion samples were measured using the software ImageJ 1.47v (National Institute of Health, USA). The diameters of at least 100 droplets from each system were measured and the data were numerically processed to obtain droplet-size distribution.

### Polarized Light Microscopic Analysis

Polarized light micrographs were obtained using Leica Abrio imaging system from CRI Inc. The samples for imaging were prepared by placing minute droplet of the emulsion on the glass slide and covering with a cover slip. A little pressure is applied to the cover slip to squeeze the sample for uniform distribution of the sample and to reduce the sample thickness in order to allow the light to transmit from opaque sample. Before imaging the sample, a background is taken.

### State of Oxidation of Graphite and the Partial Reduction of Graphene Oxide

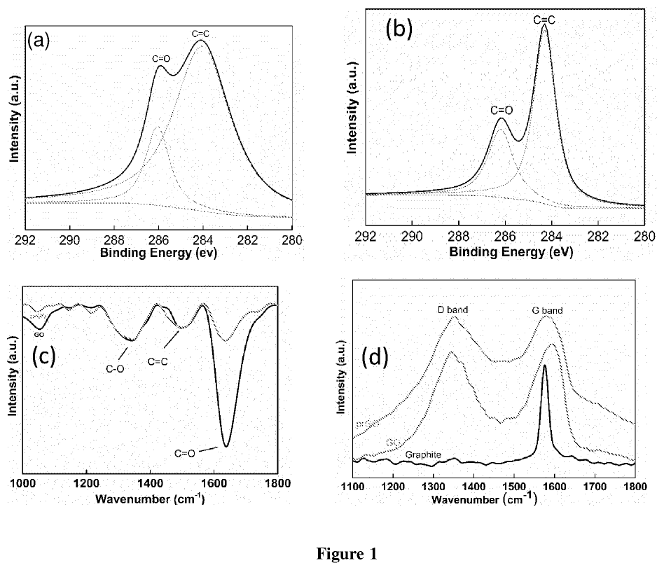

In FIG. 1 (a) and (b), The XPS spectra were fitted to different peaks corresponding to sp2 carbon (C═C) and carbonyl (C═O) functional groups. It can be observed that there is a decrease in the intensity of peak corresponding carbonyl functional group in case of partially reduced GO. This indicated that partial reduction has removed some of the carbonyl groups along with the hydroxyl groups (as can be depicted from FTIR) giving more sp2 carbon in the vicinity of interaction.

The reduction in carboxyl and carbonyl groups was confirmed by the FTIR spectroscopy as shown in FIG. 1 (c). The thermal dissociation of oxygen groups is clearly indicated in the reduced transmitted intensity of C—O groups which corresponds to —COOH and —COOR groups. Also, the thermal reduction of GO will remove some of O—H and —O— bonds at the basal plane. This reduction will expose more aromatic islands at the basal plane indicated by the C═C bonds at the basal plane which can be confirmed from the C═C stretching at ˜1634 cm⁻¹. Some hydrophilic groups at the edges are present as indicated by C—O stretching at 1344 cm⁻¹. In FIG. 1 (d), the G band will shift to lower frequency from 1593 cm⁻¹ to 1581 cm⁻¹. In reality, the complete reduction is exhibited in form of higher intensity of G band where intensity of D band decreases as compared to G band. This is because more sp² carbon comes in the vicinity and interacts to give G band intensity. Herein, the partial reductions will not only expose the sp² carbon but also there is breaking and rupturing of GO sheets leads to increase in more amorphous region and hence the higher intensity D band along with the G band shift.

### Stabilization of Oil-Water Phases Using Graphene Oxide (Oil-in-Water) and Partially Reduced Graphene Oxide as Surfactant (Water-in-Oil)

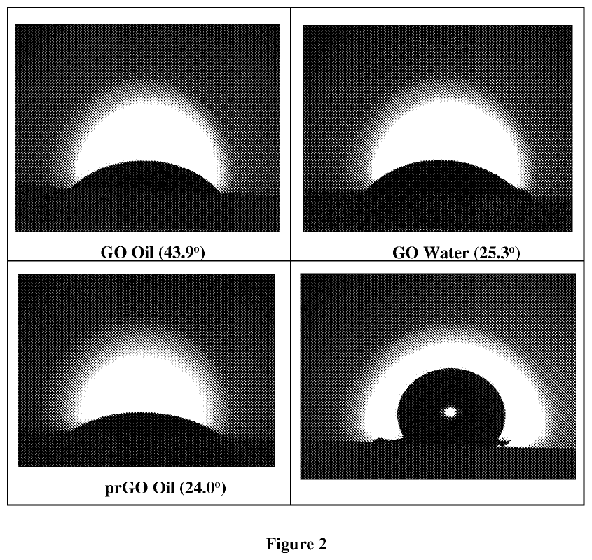

FIG. 2 shows the contact angle of a GO and prGO films treated under different solvents. GO and prGO (thermally reduced GO sheets), were deposited onto a glass film by drop-casting. he contact angle of rGO was obtained as 43.9°, 25.3°, 24.0° and 115.3° for GO, prGO. It is believed that the GO film has hydroxyl and carboxyl groups attached to the sheet edges, thus rendering GO relatively hydrophilic with a contact angle of 25.3°, which is attributed to the remaining oxygen content, as verified in the XPS and IR data. Here we hypothesized that a decrease in oxygen content would maximize hydrophobicity. First, the water contact angle is increased to 115.3° on the film of prGO from 25.0° of the plain GO film.

The partial reduction of GO gives more hydrophobic C═C bonds exposed to the water and oil interface, in comparison to that of hydrophilic C—O and C═O bonds. This increases the HLB value of graphene oxide and it falls in the HLB range for a water-in-oil emulsion. This high HLB graphene oxide makes the oil to stay as continuous phase leading to w/o emulsion with graphene oxide encapsulating the water phase.

As can be evident from the confocal images that pristine GO have fewer sheets which are more hydrophobic and can make water-in-oil emulsion. With partial reduction, more GO sheets are available with high HLB and makes entire volume of the water get dispersed in the oil continuous phase making a stable water-in-oil emulsion.

It is observed that the GO with its greater hydrophilicity wet the water phase, get dispersed and water makes the continuous phase. The oil droplets are stabilized in the water with their surface energy minimized by the GO at the interface. With increase in HLB value, hydrophobic domains wet the oil phase and oil forms the continuous phase leaving water in the form of droplets stabilized by some of the hydrophilic functional groups on the GO sheets. This transition from o/w to w/o is due to the change in HLB value arises due to the partial reduction of pristine GO.

As can be evident from the confocal images that pristine GO have fewer sheets which are more hydrophobic and can make water-in-oil emulsion. With partial reduction, more GO sheets are available with high HLB and makes entire volume of the water get dispersed in the oil continuous phase making a stable water-in-oil emulsion.

Moreover, with more reduction, the GO sheets will have less hydrophillicity to stabilize the water phase and emulsion will not form at all, leaving reduced GO sheets at the bottom of the vial.

As discussed before in confocal imaging, the change in HLB value will give the water-in-oil emulsion. The emulsion with pristine GO will hardly give a stable water-in-oil emulsion since GO sheets are highly hydrophillic having low HLB value corresponding to oil-in-water emulsion. The observed emulsion with pristine GO could be a due to the few less oxidized sheets taking part in emulsion formation.

An increase in reduction will lead to highly hydrophobic, unable to stabilize the water phase because of less or almost no hydrophillicity.

Also, it has been observed that the reduced GO sheets have low affinity to water and are found to be separated and some in the oil phase surrounding the water droplets.

### De-Stabilization Studies and Coalescence Dynamics of the W/O Emulsion Without Emulsifier

The dispersed water phase has low to high compression with high to low volume fraction of oil continuous. At high oil volume fraction, the water droplets are dispersed uniformly and are spherical in shape. With decrease in the continuous phase, the droplets tend to come closer and approaches adjacent to each other. At some volume fraction when droplets are almost touching each other, compression takes place. This compression will lead to droplet deformation and droplets are no longer spherical rather they take up polygon shape to be stable in the emulsion.

More and more compression due to lesser volume fraction, the droplets will be compact. With very less volume fraction of oil phase of around 10%, droplets start breaking and emulsion structure destructs and will no longer be stable.

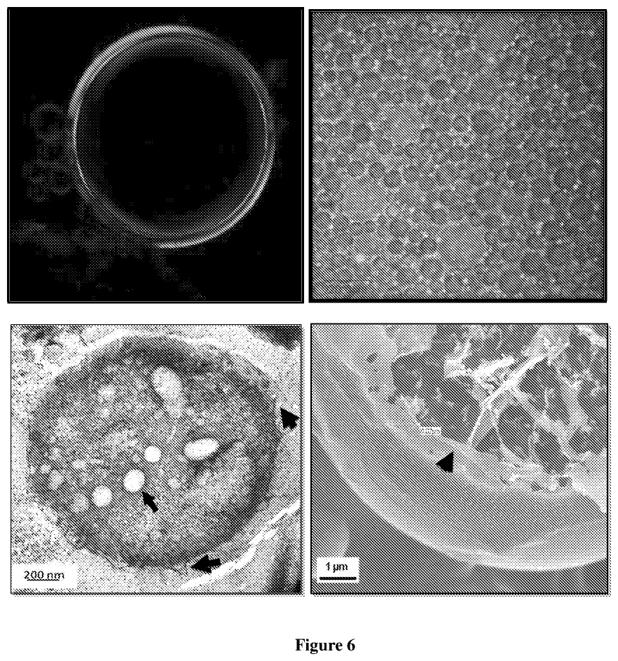

The synthesized GO emulsion is stable up to 20 days from the day of its production. The pictures on the top gives the visual picture of how the emulsion is getting destabilized. The confocal images are taken on every 4th day from the day of emulsion formation to investigate the destabilization mechanism of the emulsion (FIG. 6).

It is evident from the confocal imaging that the most prevailing de-stabilization mechanisms either Oswald ripening or Coalescence, details will be discussed in further section. In this mechanism, the smaller droplets merge to form bigger droplets thereby increasing the volume of droplets. At the same time, bigger droplets combine to give a larger mass of droplet and eventually forming a separate phase. Physically, this can be seen by the appearance of water phase in the emulsion.

In general, highly concentrated emulsions are viscoelastic in nature and the viscoelasticity is characterized by dynamic rheological measurements, where an oscillatory shear is applied. It has been demonstrated that the typical evolution of the storage modulus (G′) and loss modulus (G″) of the freshly prepared neat emulsion with respect to the increase in strain amplitude at a constant frequency of 1 Hz.

It is also observed that elastic modulus is greater than the viscous modulus in the linear viscoelastic domain. The elastic-to-viscous transition (cross-over) of water-in-oil emulsion takes place at a lower value of Υ*=0.01 as compared to that of oil-in-water emulsion with Υ*=40.

With respect to oscillatory shear measurements at the linear viscoelastic domain for the neat emulsions, the elastic modulus is almost constant in a wide frequency range covering several orders of magnitude. In the high frequency region, the elastic modulus drops with increasing frequency. The wide plateau on the frequency dependence of elastic modulus is standard for ideal elastic materials, the elastic modulus of which must be independent of frequency. Hence, such kind of behavior reflects its solid like nature. Similar results have been reported in many earlier publications and the wide plateau on the frequency dependence reflects solid-like behavior highly concentrated emulsions.

The water-in-oil emulsion shows a change in elastic modulus which can be considered more like a plastic behavior due to deformation, while the oil-in-water emulsion shows a wide plateau corresponding to elastic and solid-like region. The water-in-oil emulsion shows the plastic behavior rather than the elastic or solid-like behavior. This is due to the presence of large droplets and polydispersity which makes it deform easily at higher angular frequencies.

The water-in-oil emulsion is shear thinning due to inter-droplet breakup at higher frequencies. This could be due to polydispersity and presence of large droplets. On the other hand, oil-in-water emulsion is shear thickening due to inter-droplet space and the continuous phase.

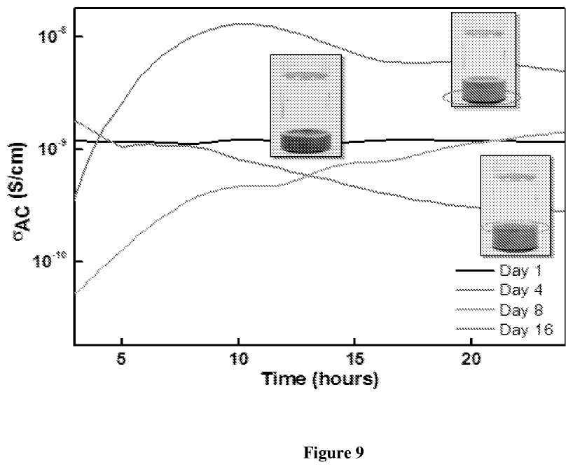

The stability of the prGO stabilized W/O emulsions against coalescence and phase separation was monitored and assessed using AC electrical conductivity and aging effect. As shown in FIG. 9, the emulsion is quite stable during first few days from its synthesis. This can be indicated by constant ‘σ_{AC}’ in the Figure. After few days, sedimentation of the emulsion and separation of the oil phase was observed in prGO stabilized emulsions as indicated by the decrease in the ‘σ_{AC}’ due to insulating oil phase. Further, the sedimentation was followed by droplet break from day 8. An increase in the ‘σ_{AC}’ due to water phase separation indicates droplets break either by Coalescence or Ostwald ripening. This destabilization accelerates and the phases completely separates by 20^{th} day from the emulsion formation. The latter shows a sudden rise in the ‘σ_{AC}’ with more and more water separates from the emulsion. This sedimentation of droplets and rapid separation of the water phase seen in the prGO stabilized emulsions indicate two likely possibilities: a) droplets are experiencing sedimentation due to a density difference, with or without any change in droplet size and b) the droplets are coalescing due to insufficient surface coverage arises due to compressed droplets in the sedimentation.

The assessment of the second destabilization mechanism after sedimentation was done using time- dependent non-linear size distribution obtained from the confocal images with aging. The average droplet size distribution curve shows a non-linear rapid decay in the average population of the droplets. This rapid decay can be attributed to the prevalence of coalescence phenomena over the Ostwald ripening.

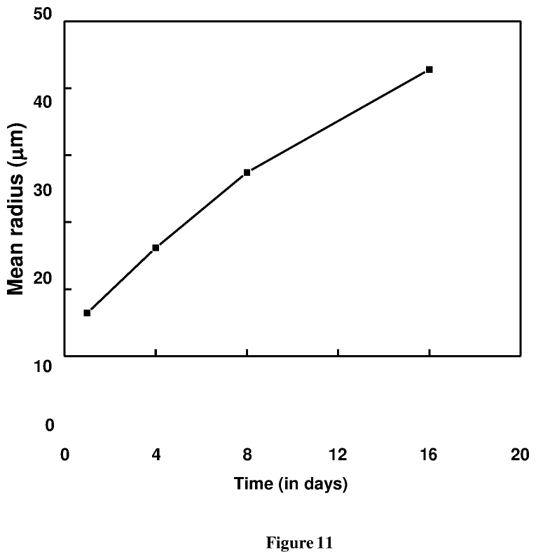

With surface layer thinning due to compression, droplets of similar sizes coalesce to form large drops. This fact gives rise to the wider distribution with time, which can be indicated by the widening of the distribution curve along with the decay in the population of smaller droplets in the same volume of the emulsion. This results clearly indicates the Coalescence to the prevailing destabilizing mechanism in the destabilization of the prGO stabilized W/O emulsion. Further, the sauter mean diameter curve in the FIG. 11, supports the argument of Coalescence destabilization in the prGO stabilized W/O emulsion.

### Example 2

### Materials and Methods

Canola oil and E 476 emulsifier were obtained from Orica Mining Services Pty. Ltd., Australia. E476 is composed of ester, amide and salt components. Other ingredients for the emulsion preparation such as Ammonium Sulphate (M=132.14 g/mol, Purity≥99.5%) was provided by Amresco Inc. GO was synthesized using Hummers' method as mentioned in earlier section.

### Synthesis of the W/O Emulsion With E-476

The W/O emulsion with E-476 was prepared with three different compositions involving aqueous phase and the fuel blend. The aqueous phase was a dispersion of GO in DI water. The fuel blend is the mixture of Canola oil and E-476. The total composition of the emulsion involved 90 wt % of the aqueous phase and 10 wt % of the fuel blend. While the aqueous phase was kept constant with 35% of the salt, the fuel blend was varied as per the variation in the emulsifier E-476 and the GO concentration. For the preparation of 100 gms of the W/O emulsion, GO was dispersed in required amount (of composition) in DI water and the emulsifier E-476 was dispersed in Canola oil such that total fuel blend composition becomes 10 wt % of the total emulsion.

For parameter dependent study, the composition was varied keeping the total weight ratio of the aqueous phase and fuel blend constant. Initially, the ratio of the aqueous phase to the fuel blend was kept constant for few samples of varying concentration of GO, emulsifier and the salt. Then, the ratio was changed with again varying the concentration of the ingredients as mentioned before. For example, for a 90:10 w/w ratio of aqueous phase to fuel blend, 0.007 wt % of GO was dispersed in 55 wt % of DI water and 1.5 wt % of emulsifier E-476 was dispersed in 8.493 wt % of Canola oil.

Once the compositions were taken, aqueous phase was stirred and heated till 60° C. temp attained. Stirring is needed to avoid flocculation of GO. On the other hand, the fuel blend was heated to 60° C. temp. The aqueous phase was then slowly added to the hot fuel blend along with shearing at a rotational speed of 700 rpm using a Jiffy impeller of Caframo BDC1850 high shear mixer for 1 minute. The mixing continued for next 5 minutes until viscous brown colored coarse emulsion formed. In some cases, where GO concentration was more or the emulsifier E-476 was less, the stirring was continued until residual aqueous phase gets emulsified. Thereafter, the formed emulsion was refined for next 15 minutes by mixing at a speed of 1400 rpm. All the prepared emulsions were refined for same time to maintain an equilibrium refining time.

### Synthesis of the W/O Emulsion With E-476 (Without GO)

The W/O emulsion with E-476 was prepared with a same procedure as described earlier. Here, the aqueous phase was just the DI water. The composition varied slightly on the fuel blend side. The concentration of GO as taken earlier has been replaced by an equal amount of the Canola oil, rest all ingredients were in the same concentration as mentioned earlier.

### Synthesis of the Dummy Emulsion Explosive With E-476 and GO

This emulsion is same as earlier, the only difference is supersaturated solution of salt with 35 wt % is used herein. As earlier, the GO dispersion was used and required amount of salt was added to it. The aqueous phase here was called the oxidizer solution. This oxidizer solution was heated to 70° C. temp until the salt dissolves. Then, the procedure of emulsion preparation was followed as earlier.

### Characterization

### Rheological Measurements

The rheological measurements were carried out at room temperature in Anton Paar modular compact rheometer (Physica MCR 301). The data were collected using a parallel-plate geometry (diameter 25 mm) and the gap between the plates was 1 mm.

The experiments were carried out in the following deformation modes:

1. Amplitude sweep oscillations in the range of strains from 0.1 to 500% at the constant frequency of 1 Hz. The amplitude sweep method was used to ensure that the obtained values of dynamic elastic moduli in a linear regime of deformations.

2. Frequency sweep: Oscillating regimes of deformations in the range of frequencies from 0.01 to 100 Hz.

### Thermal Imaging

The thermal imaging was done using FLIR-i7 thermal camera. About 1 gm of the emulsion sample was placed uniformly on a flat plate spatula and heated on a hot plate at about 90° C. temp. Only two kind of samples were in this measurement to assess how fast the heat is transferred viz. emulsion with GO and the emulsion without GO.

### Thermal Conductivity Measurements

The thermal conductivity of the emulsion was measured by using TCi C-Therm thermal conductivity analyzer at 60° C. temp. A T-shaped TCi sensor was used for measurement. Before testing the emulsion sample, the sensor was first calibrated to room temperature as well as a standard sample. In this case, polymer sample was used to calibrate the sensor. This was done to ensure the sensor surface coated with ceramic is functional and unaffected by thermal shock of any previous measurements. For testing, a very small amount of the emulsion sample was smeared onto the sensor such that the sensing area (having electronic chip) is covered entirely by the sample. The sample coated sensor was kept inside a furnace to keep the temp uniform throughout the measurement. Around 10 sampling values of the thermal conductivity were then recorded and averaged to give actual value of the thermal conductivity.

### Effect of E-476 Concentration on the Droplet Size Distribution

The W/O emulsion was prepared with varying amount of emulsifier. Three different concentrations of E-476 was used to prepare the emulsion viz. 3 wt %, 0.3 wt % and 0.15 wt %. The total weight of the emulsion prepared was 100 grams and the composition of the phases were kept constant. The aqueous phase which is GO dispersed water was 90% of total emulsion while the oil phase which is Canola oil plus E-476 was 10% of the total emulsion.

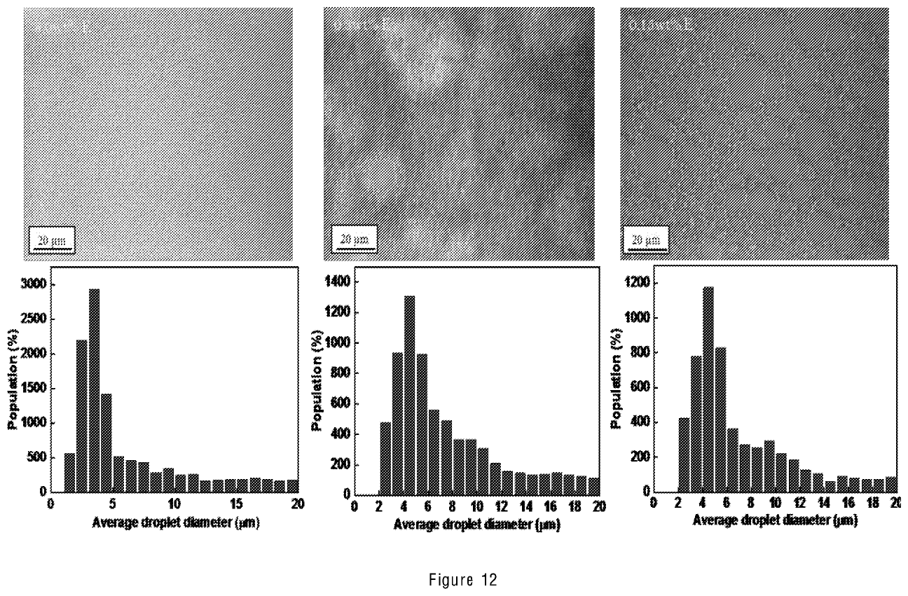

FIG. 12(a) indicates the finer droplet size and the relevant distribution. At high concentration of E-476, the emulsifier action prevails, stabilizing more and more water droplets giving finer droplets, higher stability with droplet size distribution at lower average droplet diameter value (2-3 microns). Reducing the concentration of E-476 to about 0.3 wt %, refining not uniform leading formation of large size droplets and polydispersity increases as indicated in FIG. 12(b).

The distribution shifts to large average droplet diameter with distribution showing increased population of large sized droplets. Further reduction in the E-476 as in FIG. 12(c), lesser number of droplets taking part in refining leading to increase in the number of large sized droplets and polydispersity further increases as compared to that of 0.3 wt % emulsifier. The droplets size distribution accordingly will also shift to higher average droplet diameter with more number of large droplets. This polydispersity and formation of large droplets could be due the fact that with the decrease in the E-476 concentration, GO concentration dominates. GO being a surfactant will compete with E-476 to go to interface, trying to reducing interfacial energy.

### Effect of E-476 Concentration on the Rheological Properties

Rheological properties of the W/O emulsion with varying amount of emulsifier were evaluated. Oscillatory measurements were done for all emulsions having three different concentrations of E-476 viz. 3 w/w, 0.3 w/w and 0.15 w/w.

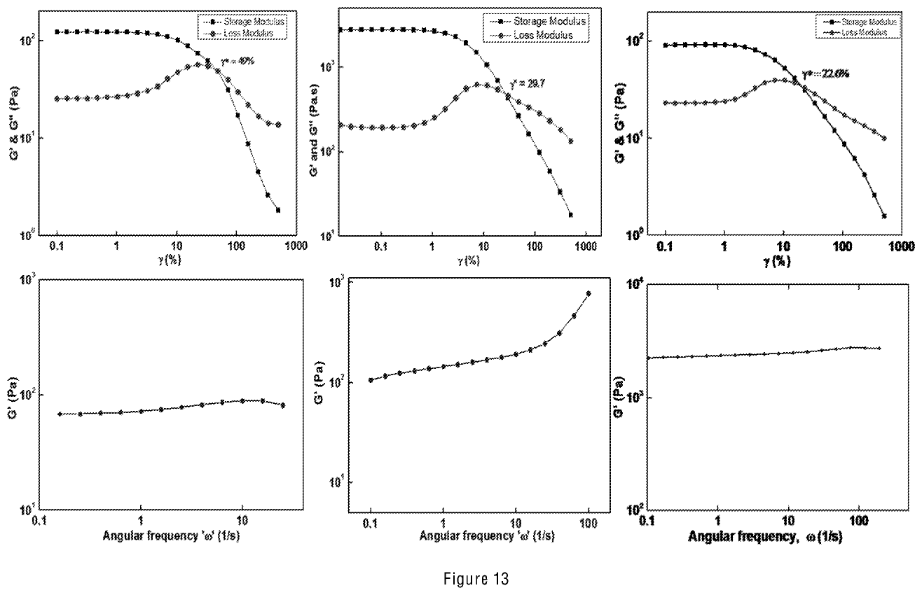

Being a highly concentrated emulsions the W/O here are viscoelastic in nature and the viscoelasticity is characterized by dynamic rheological measurements, where an oscillatory shear is applied. The amplitude sweep (strain sweep) plots of highly concentrated emulsions are shown in FIG. 13 (a), (b) and (c). The plots demonstrates the typical evolution of the storage modulus (G′) and loss modulus (G″) at a constant frequency of 1 Hz. The elastic-to-viscous transition (cross-over) for the emulsions takes place at a specific of the strain amplitude, represented as Υ*. This cross-over point is different for the emulsions with different E-476 concentrations and is a point of discussion in this section as well as later sections of the oscillatory shear measurements.

For emulsion with E-476 concentration 3.0 wt % as represented in FIG. 13(a), the elastic modulus and loss modulus are linear for a large amplitude of strain and is independent of the strain in an amplitude domain up to γ=49%, the cross-over point γ*. At higher values than γ*, deformation starts and the moduli no longer remain constant. This high value of elastic-to-viscous transition is indicative of the presence of the finer droplet and monodisperse droplet distribution which is in-sync our analysis in the previous section.

With increase in the E-476 concentration, the deformation takes place at lower strain amplitude. For E-476 concentration equal to 0.3 wt %, the deformation occurs at a strain amplitude γ=29.7%, lower than at 3.0 wt % as seen in FIG. 13(b). This could be indicative of the formation of large droplets whose short-term relaxation and droplet break-up at lower strain leads to the deformation. This analysis is confirmation of lower refinement due to the prominence of GO with decrease in E-476 concentration. On further reducing the E-476 concentration to 0.15 wt % as in FIG. 13(c), the deformation occurs at an strain amplitude γ=22.6% indicative of the formation of more and more larger droplets and polydispersity with the decreased E-476 molecules for refinement.

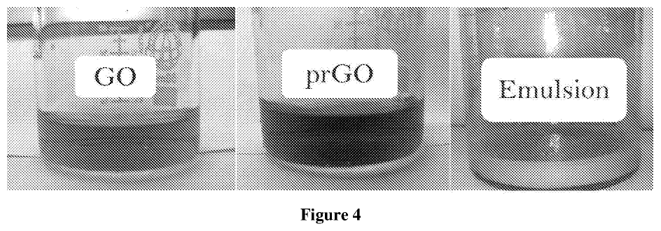

FIG. 13 (d), (e) and (f) shows the frequency dependence of the elastic modulus at a constant strain amplitude γ=0.1%. At high E-476 concentration of 3.0 wt % (FIG. 13 (d)), the elastic modulus is nearly constant for a wide frequency range covering several orders of magnitude, though at the high frequency region, the elastic modulus drops slightly with increasing frequency due to short-term relaxation caused by droplet deformation. The wide plateau on the frequency dependence of elastic modulus is standard for ideal elastic materials, the elastic modulus of which must be independent of frequency. Hence, such kind of behavior reflects its solid like nature. Similar results have been reported in many earlier publications and the wide plateau on the dependence reflects solid-like behavior highly concentrated emulsions. With decrease in E-476 concentration to 0.3 wt % (FIG. 13(e)), the elastic modulus no longer remains constant for a wide range of frequencies as compared to that at 3.0 wt % E-476. The elastic drop occurs at around the frequency 50 Hz which was at 100 Hz for 3.0 wt % E-476. Further decreasing the E-476 concentration to 0.15 wt %, the drop occurs at 10 Hz at shown in FIG. 4-2(f). Also, the elastic modulus is no longer remain constant for a wide frequency range even at lower frequencies. This can be attributed to the lesser refinement leading larger droplet size and polydispersity which makes deformation easy via droplet break-up. This results are in consistence with the microscopy and droplet size distribution analysis indicative of decrease in refinement with the decrease in the E-476 concentration and prominence of GO at the interface.

### Effect of GO Concentration on the Droplet Size Distribution

The W/O emulsion was prepared with varying amount of the GO. Four different concentrations of GO were used to prepare the emulsion viz. 0.007 wt %, 0.014 wt %, 0.025 wt % and 0.052 wt %. The total weight of the emulsion prepared was 100 grams and the composition of the phases were kept constant. The fuel blend which is mixture of E-476 and Canola oil was kept constant at 10 wt % in which Canola oil constitutes 7 wt % and E-476 constitutes 3 wt % in total emulsion volume.

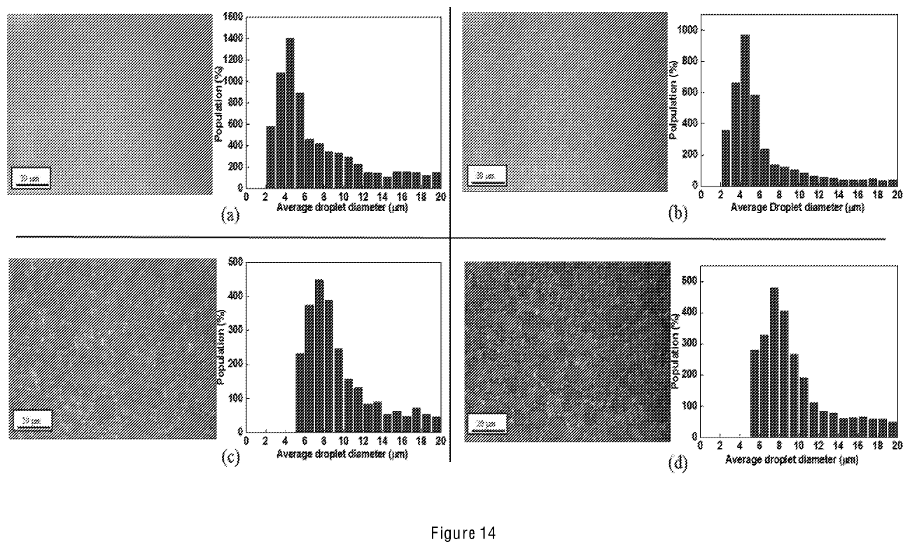

FIG. 14(a) indicates the finer droplet size and the relevant distribution. At low concentration of GO, the emulsifier action prevails, stabilizing more and more water droplets giving finer droplets, higher stability with droplet size distribution at lower average droplet diameter value (2-5 microns). Increasing the GO concentration to about 0.007 wt %, refining not uniform leading formation of large size droplets and polydispersity increases as indicated in FIG. 14(b). The distribution shifts to large average droplet diameter with distribution showing increased population of large sized droplets. Further increase in the GO concentration as in FIG. 14(c), lesser number of droplets taking part in refining by E-476 leading to increase in the number of large sized droplets and polydispersity further increases as compared to that of 0.007 wt % GO. The droplets size distribution accordingly will also shift to higher average droplet diameter with more number of large droplets. The increase will not only hinder the refining of droplets but also makes the formation of emulsion difficult. Result is that not entire volume of water taken emulsified, there will be a very small volume of aqueous phase seen after the refinement. This occurs when the GO concentration increased above 0.025 wt %. Also, this will leave some residual GO in the emulsion which can be seen by the blur image in the FIG. 14(c) and FIG. 14(d). Not all the GO could take part in the emulsification since there may be competition between GO sheets and E-476 molecules to reach the interface. With the increase in the GO concentration, this competition may lead to barrier action by GO to the emulsifier making the refinement difficult. On the other, the E-476 may also acquire some of the interfaces leaving the GO sheets which can be seen in the blur image. This inhibition action by the GO could be attributed to the strong surfactant properties of the GO accounted for the amphiphilic nature of the GO. This somehow also indicates the presence of the GO at the interface. FIG. 14(d) shows larger sized droplets than all other compositions of GO and E-476 concentration discussed in the previous and have high polydispersity. The droplet size distribution shifts to large droplets sizes.

### Effect of GO Concentration on the Rheological Properties

Rheological properties of the W/O emulsion with varying amount of GO were evaluated in the same way as described in the previous section. Oscillatory measurements were done for all emulsions having four different concentrations of GO viz. 0.007 wt %, 0.014 wt %, 0.025 wt % and 0.052 wt %.

For emulsion with GO concentration 0.007 wt % the elastic modulus and loss modulus are linear for a large amplitude of strain and is independent of the strain in an amplitude domain up to γ=49%, the cross-over point γ*. This high value of elastic-to-viscous transition is indicative of the presence of the finer droplet and monodisperse droplet distribution.

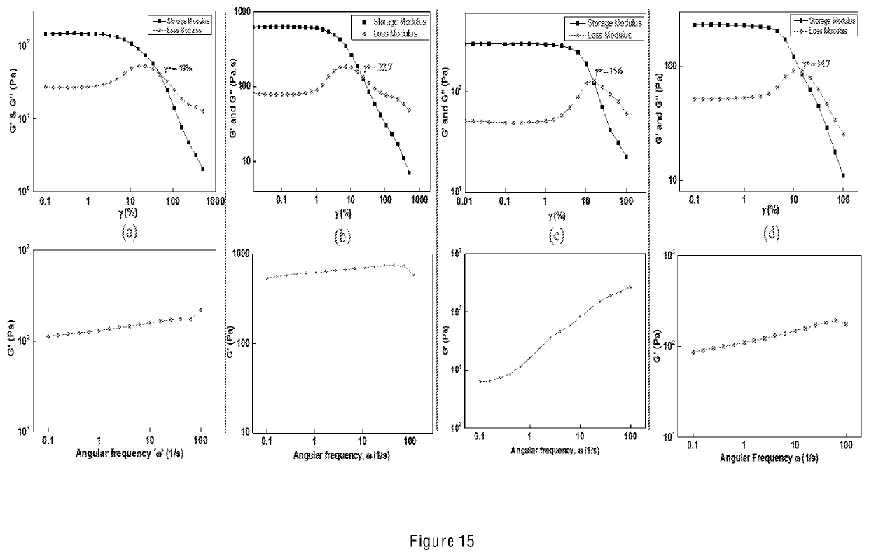

With increase in the GO concentration, the deformation takes place at lower strain amplitude. For GO concentration equal to 0.014 wt %, the deformation occurs at a strain amplitude γ=22.7%, as seen in FIG. 15(b). This analysis is confirmation of lower refinement due to the prominence of GO. On further increasing the GO concentration to 0.025 wt % as in FIG. 15(c), the deformation occurs at an strain amplitude γ=15.6% indicative of the formation of more and more larger droplets due to barrier action by the GO. On further increase to 0.052 wt % GO (FIG. 15(d)), the strain amplitude lower to γ=14.7% which can be attributed to the inhibitory action by GO to E-476 molecule.

FIG. 15 (e), (f), (g) and (h) shows the frequency dependence of the elastic modulus at a constant strain amplitude γ=0.1%. At low GO concentration of 0.007 wt % (FIG. 15(e)), the elastic modulus is nearly constant for a wide frequency range covering several orders of magnitude, though at the high frequency region, the elastic modulus drops slightly with increasing frequency due to short-term relaxation caused by droplet deformation. The wide plateau on the frequency dependence of elastic modulus is standard for ideal elastic materials, the elastic modulus of which must be independent of frequency. In FIG. 15(f), the elastic modulus plateau decrease to lower value indicative of the formation of some large droplets in the emulsion. With increase in the GO concentration to 0.025 wt % (FIG. 15(g)), the elastic modulus no longer remains constant for a wide range of frequencies. The elastic modulus drop occurs at around the frequency 100 Hz. Further increasing the GO concentration to 0.052 wt % as in FIG. 15(h), the elastic modulus increases with increase in the frequency. This can be attributed to the loss in elastic behavior of the emulsion which may be due to droplet break-up and deformation occurs very low frequencies.

### Effect of Salt Concentration on the Droplet Size Distribution

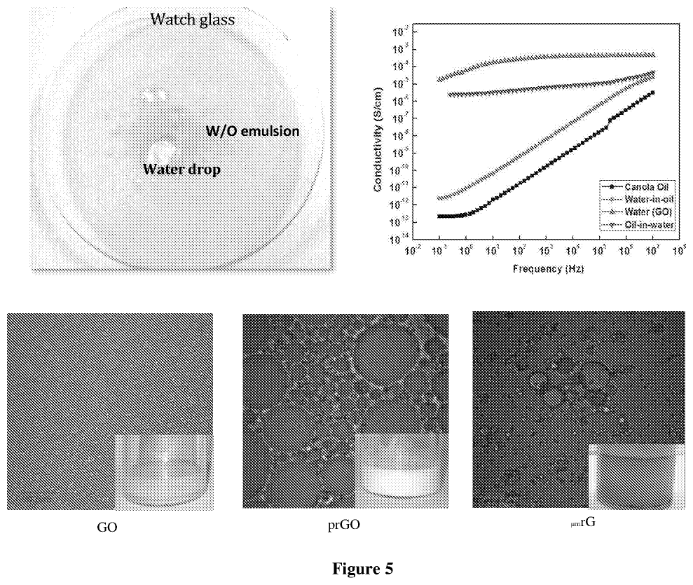

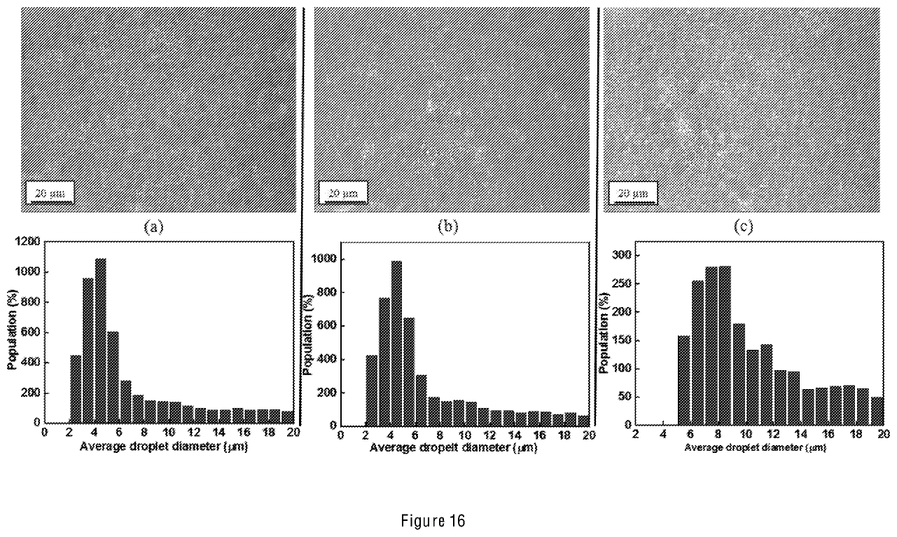

FIG. 16 shows confocal images and the corresponding droplet size distribution of the emulsion with varying concentration of the salt. The concentration of the GO and E-476 are kept constant in order have finer droplets with monodisperse droplets size distribution. As can be seen from FIG. 16(a), though the emulsion has finer droplets, the flocculation of GO makes the emulsion refining difficult. The as-synthesized GO is electrostatically charged, addition of salt screens the charges on the edges of the GO sheets. This will agglomerate the GO in the oxidizer solution during emulsion preparation. The GO agglomerates hinder the shearing action during mixing step. Hence, formation of new interfaces by water droplet break-up gets limited and lesser droplets take part in the emulsion formation resulting in the residual GO and crystallized salt in the emulsion. This can be seen in the confocal images. With the increase in the salt concentration, more and more GO agglomerates hinder the emulsification, increasing the droplet size and residual ingredients as shown in FIG. 16(b). At very high concentration of 35 wt % (FIG. 4-5(c)), the residual ingredients and large droplets decreases the emulsion volume to a large fraction out of total composition. Emulsion does not form at the salt concentration higher than 35 wt %.

### Influence of GO at the Interface of the E-476 Emulsified W/O Emulsion

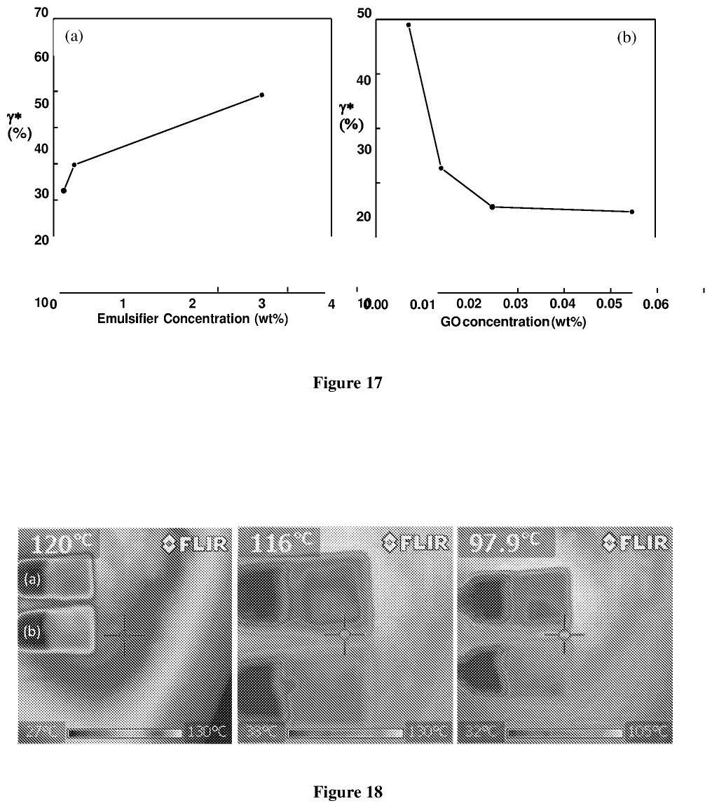

FIG. 17 shows the surfactant action of the GO at the interface of the W/O emulsion. The results are derived from oscillatory measurements of the emulsion. The cross-over strain amplitude was recorded and plotted against the (a) E-476 concentration and the (b) GO concentration. With the increase in the E-476 concentration, the elastic-to-viscous transition occurs at high strain amplitude. This could be due to the increase in the E-476 molecules taking part in the emulsification and dominates over the GO sheets. At low concentration, GO competes with E-476 in going to interface to minimize the total interfacial energy and acts as a barrier for emulsification. With the increase in GO concentration, more and more GO sheets would like to take part in minimizing the interfacial energy. Since GO is amphiphilic in nature, it acts as a strong surfactant to stabilize oil-water interfaces. In presence of another emulsifier in the same oil-water mixture, GO and the emulsifier individually trying to stabilize the interface and inhibits each other's action producing large droplets with polydispersity; leading to deformation at low stresses. Hence, on this basis it can be predicted that the GO is at the interface of the synthesized 90:10 W/O emulsion.

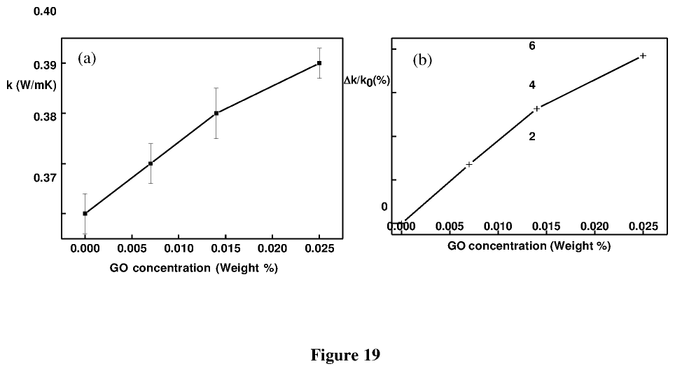

Thermal imaging of the neat W/O emulsion and GO incorporated W/O emulsion The synthesized W/O emulsion without GO and the W/O emulsion with GO (0.014 wt %) were imaged using thermal Infra-red camera. The images were taken on 90° C. temp heated hot plate at every 5 minutes. As can be seen from the FIG. 18, initially the heating rate of both the emulsion was constant. After 15 minutes, the emulsion (b) heats up more rapidly than the emulsion (a). This behavior continues for next 15 minutes i.e. after 30 minutes from start of the heating. This indicates that rate of heat transfer is higher in case of emulsion (b) than emulsion (a). This can be attributed to the fact that thermally conducting GO at the interface of the W/O emulsion may enhances the thermal conductivity of the emulsion. This test motivates for further analysis and evaluation of thermal conductivity of the emulsion.

### Thermal Conductivity of the GO Incorporated W/O Emulsion

Thermal imaging by the IR camera predicts that there could have an enhancement in the thermal conductivity of the emulsion with GO at the interface. The W/O emulsion with GO were explored further for the determination of thermal conductivity at various of GO concentration. Table 1 shows the thermal conductivity of emulsions with varying concentration at the same emulsion composition. It can be clearly depicted from the table that there is an enhancement in the thermal conductivity of emulsion with the increase in the GO concentration. A mild increase in the thermal conductivity may be due to very low concentration of GO in the total emulsion. Higher concentration makes the emulsion formation difficult due to inhibition action as discussed earlier.

TABLE 1
Thermal conductivity of the emulsion with respect
to the GO concentration. Emulsion composition has been kept
constant with 35% of the (NH4)₂SO₄ salt.

| GO | | |
|---|---|---|
| Concentration | Emulsion composition | Thermal conductivity |
| (weight %) | (Aqueous phase:fuel blend) | ‘k’ (W/mK) |
| 0 | 90:10 | 0.37 ± 0.004 |
| 0.007 | 90:10 | 0.38 ± 0.004 |
| 0.014 | 90:10 | 0.39 ± 0.005 |
| 0.025 | 90:10 | 0.40 ± 0.003 |

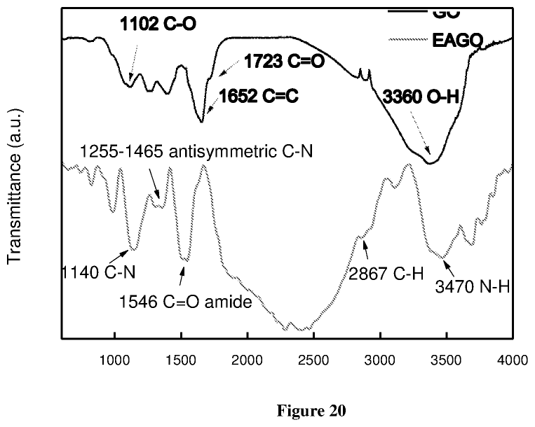

FIG. 19(b) shows the percentage enhancement in the thermal conductivity of the GO incorporated W/O emulsion with respect to the increase in the GO concentration. At very low concentration of GO, the enhancement is of the order of 2% only. With increase in the concentration, the enhancement is more. At high concentration, the enhancement is about 7%, which is highest with maximum GO concentration that can be used to prepare emulsion.

### Example 3

### Materials and Methods

Canola oil and E 476 emulsifier were obtained from Orica Mining Services Pty. Ltd., Australia. E476 is composed of ester, amide and salt components. Other ingredients for the emulsion preparation such as Ammonium Sulphate (M=132.14 g/mol, Purity≥99.5%) was provided by Amresco Inc. Salts such as Ammonium chloride, Sodium aceate and Thiourea were obtained from Merck Pvt. Ltd. GO was synthesized using hummers' method as mentioned in earlier section. Thionyl chloride and ethylene diamine were obtained from Merck Pty. Ltd.

### Functionalization of GO

GO was functionalized using thionyl chloride and ethylene diamine. 1 gm of GO was dispersed in 50 gm of Thionyl chloride in presence of 1 ml DMF. It was stirred for 24 hours at 70° C. temp. After the completion of the reaction the reaction mixture was washed, filtered and dried in vacuum oven for 6 hours. 0.5 gm of above chloride functionalized was mixed with 40 ml of Ethylene diamine and stirred for 6 hours at 60° C. temp. The final reaction mixture was carefully washed, filtered and dried in oven. This fGO was dispersed in the Canola oil along with E-476 for emulsion synthesis.

### Synthesis of the W/O Emulsion With E-476

The W/O emulsion with E-476 was prepared with three different compositions involving aqueous phase and the fuel blend. The aqueous phase was a dispersion of GO in DI water. The fuel blend is the mixture of Canola oil and E-476. The total composition of the emulsion involved 90 wt % of the aqueous phase and 10 wt % of the fuel blend. While the aqueous phase was kept constant with 35% of the salt, the fuel blend was varied as per the variation in the emulsifier E-476 and the GO concentration. For the preparation of 100 gms of the W/O emulsion, GO was dispersed in required amount (of composition) in DI water and the emulsifier E-476 was dispersed in Canola oil such that total fuel blend composition becomes 10 wt % of the total emulsion.

For parameter dependent study, the composition was varied keeping the total weight ratio of the aqueous phase and fuel blend constant. Initially, the ratio of the aqueous phase to the fuel blend was kept constant for few samples of varying concentration of GO, emulsifier and the salt. Then, the ratio was changed with again varying the concentration of the ingredients as mentioned before. For example, for a 90:10 w/w ratio of aqueous phase to fuel blend, 0.007 wt % of GO was dispersed in 55 wt % of DI water and 1.5 wt % of emulsifier E-476 was dispersed in 8.493 wt % of Canola oil.

Once the compositions were taken, aqueous phase was stirred and heated till 60° C. temp attained. Stirring is needed to avoid flocculation of GO. On the other hand, the fuel blend was heated to 60° C. temp. The aqueous phase was then slowly added to the hot fuel blend along with shearing at a rotational speed of 700 rpm using a Jiffy impeller of Caframo BDC1850 high shear mixer for 1 minute. The mixing continued for next 5 minutes until viscous brown colored coarse emulsion formed. In some cases, where GO concentration was more or the emulsifier E-476 was less, the stirring was continued until residual aqueous phase gets emulsified. Thereafter, the formed emulsion was refined for next 15 minutes by mixing at a speed of 1400 rpm. All the prepared emulsions were refined for same time to maintain an equilibrium refining time.

### Synthesis of the Dummy Emulsion Explosive With E-476 and fGO

This emulsion is the same as earlier, the difference is supersaturated solution of salt with 35 wt % is used herein. As earlier, the GO dispersion was used and required amount of salt was added to it. The aqueous phase here was called the oxidizer solution. This oxidizer solution was heated to 70° C. temp until the salt dissolves. Then, the procedure of emulsion preparation followed what was described earlier.

### Characterization

### Rheological Measurements

The rheological measurements were carried out at room temperature in Anton Paar modular compact rheometer (Physica MCR 301). The data were collected using a parallel-plate geometry (diameter 25 mm) and the gap between the plates was 1mm.

The experiments were carried out in the following deformation modes:

1. Amplitude sweep oscillations in the range of strains from 0.1 to 500% at the constant frequency of 1 Hz. The amplitude sweep method was used to ensure that the obtained values of dynamic elastic moduli in a linear regime of deformations.

2. Frequency sweep: Oscillating regimes of deformations in the range of frequencies from 0.01 to 100 Hz.

### Thermal Imaging

The thermal imaging was done using FLIR-i7 thermal camera. About 1 gm of the emulsion sample was placed uniformly on a flat plate spatula and heated on a hot plate at about 90° C. temp. Only two kind of samples were in this measurement to assess how fast the heat is transferred viz. emulsion with fGO and the emulsion without GO.

### Thermal Conductivity Measurements

The thermal conductivity of the emulsion was measured by using TCi C-Therm thermal conductivity analyzer at 60° C. temp. A T-shaped TCi sensor was used for measurement. Before testing the emulsion sample, the sensor was first calibrated to room temperature as well as a standard sample. In this case, polymer sample was used to calibrate the sensor. This has to be done to ensure the sensor surface coated with ceramic is functional and unaffected by thermal shock of any previous measurements. For testing, a very small amount of the emulsion sample was smeared onto the sensor such that the sensing area (having electronic chip) is covered entirely by the sample. The sample coated sensor was kept inside a furnace to keep the temp uniform throughout the measurement. Around 10 sampling values of the thermal conductivity were then recorded and averaged to give actual value of the thermal conductivity.

### Functionalization Extent of the GO

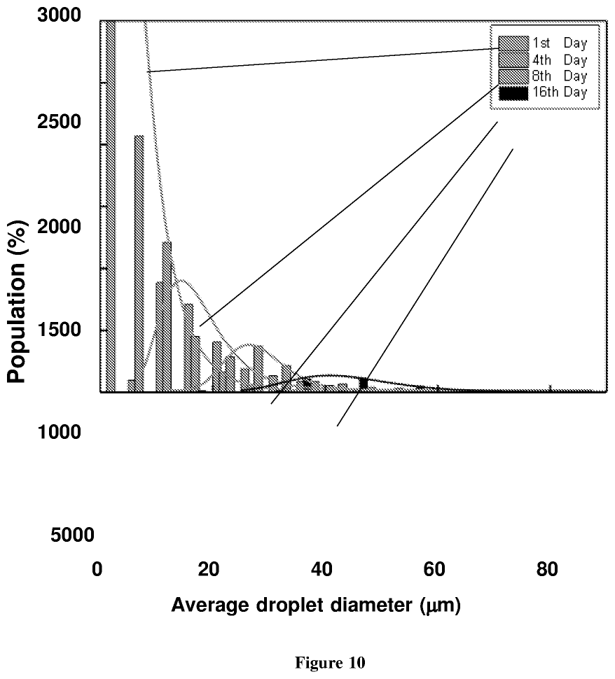

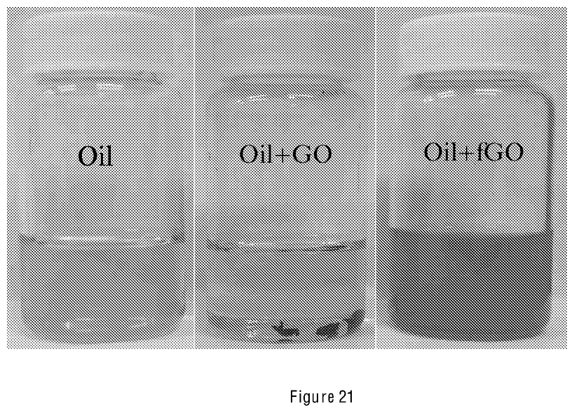

The functionalization in GO in carboxyl and carbonyl groups was confirmed by the FTIR spectroscopy as shown in FIG. 20. The amide functionalization of oxygen groups is clearly indicated in the reduced transmitted intensity of C—O—NH₂ groups which corresponds to —COOH and —COOR groups. Also, the thermal reduction of GO will remove some of O—H and —O— bonds at the basal plane²⁰From FIG. 10, it can be seen that the amide formation is indicated by peaks at 1546 cm⁻¹ while presence of primary amines is indicated by shift at 3470 cm⁻¹.The antisymmetric C—N peak and shoulder between 1255-1465 cm−1 can be attributed to free amine group of EDA whose one amine group attached to carbonyl via amide linkage.

### fGO Dispersion in Canola Oil

GO and fGO were dispersed in 5 ml canola oil with a concentration of 1 mg/ml by ultrasonicating for 30 min. The GO emulsion is maintained at 0.01 wt % fGO. This dispersion was heated to 65° C. temp on a water bath. 2 ml of Canola oil is taken in a vial and heated to. Canola oil was stirred at 600 rpm using a high shear mixer and GO dispersion was added to it slowly. The addition was done in such a way that entire 8 ml of GO was fully added within 1 minute. The stirring was continued for next 2 minutes. Further, the shearing speed was increased to 1400 rpm and the mixer was stirred for next 2 minutes.

### Microscopy and Droplet Size Distribution With Respect to GO and fGO

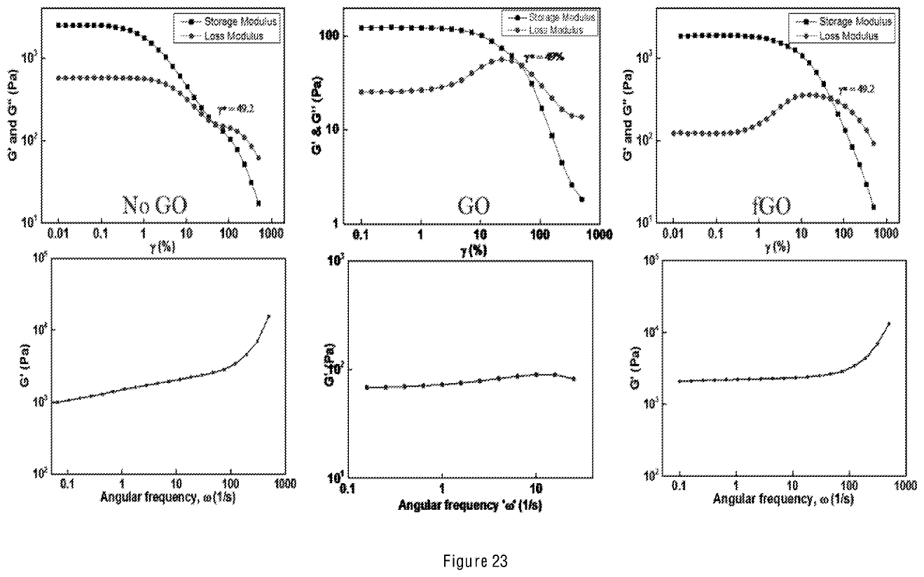

FIG. 22 shows confocal images and the corresponding droplet size distribution of the emulsion with varying concentration of the salt. The concentration of the GO and E-476 are kept constant in order have finer droplets with monodisperse droplets size distribution. As can be seen from FIG. 22(a), though the emulsion has finer droplets, the flocculation of GO makes the emulsion refining difficult. The as-synthesized GO is electrostatically charged, addition of salt screens the charges on the edges of the GO sheets. This will agglomerate the GO in the oxidizer solution during emulsion preparation. The GO agglomerates hinder the shearing action during mixing step. Hence, formation of new interfaces by water droplet break-up gets limited and lesser droplets take part in the emulsion formation resulting in the residual GO and crystallized salt in the emulsion. This can be seen in the confocal images. With the increase in the salt concentration, more and more GO agglomerates hinder the emulsification, increasing the droplet size and residual ingredients as shown in FIG. 22(b). At very high concentration of 0.1 wt % fGO (FIG. 22(c)), the residual ingredients and large droplets decreases the emulsion volume to a large fraction out of total composition.

### Rheological Properties With Respect to GO and fGO

Rheological properties of the W/O emulsion with varying amount of emulsifier were evaluated. Oscillatory measurements were done for all emulsions having three different concentrations of E-476 viz. 3 w/w, 0.3 w/w and 0.15 w/w.

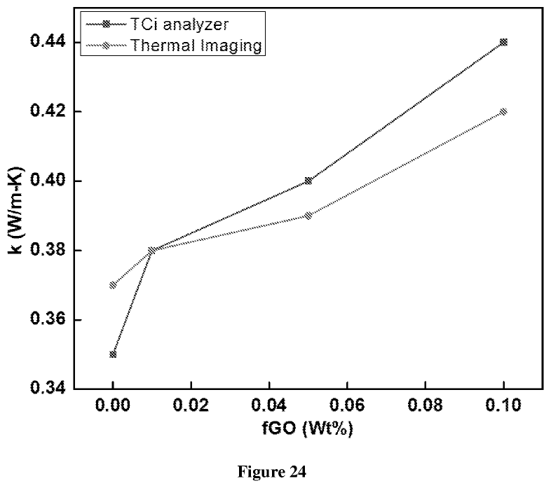

Being a highly concentrated emulsions the W/O here are viscoelastic in nature and the viscoelasticity is characterized by dynamic rheological measurements, where an oscillatory shear is applied. The amplitude sweep (strain sweep) plots of highly concentrated emulsions are shown in FIG. 23 (a), (b) and (c). The plots demonstrates the typical evolution of the storage modulus (G′) and loss modulus (G″) at a constant frequency of 1 Hz. The elastic-to-viscous transition (cross-over) for the emulsions takes place at a specific of the strain amplitude, represented as Υ*. This cross-over point is different for the emulsions with different E-476 concentrations and is a point of discussion in this section as well as later sections of the oscillatory shear measurements.

For emulsion with E-476 concentration 3.0 wt % as represented in FIG. 23(a), the elastic modulus and loss modulus are linear for a large amplitude of strain and is independent of the strain in an amplitude domain up to γ=49%, the cross-over point γ*. At higher values than γ*, deformation starts and the moduli no longer remain constant. This high value of elastic-to-viscous transition is indicative of the presence of the finer droplet and monodisperse droplet distribution which is in-sync our analysis in the previous section.

With increase in the E-476 concentration, the deformation takes place at lower strain amplitude. For E-476 concentration equal to 0.3 wt %, the deformation occurs at a strain amplitude γ=29.7%, lower than at 3.0 wt % as seen in FIG. 23(b). This could be indicative of the formation of large droplets whose short-term relaxation and droplet break-up at lower strain leads to the deformation. This analysis is confirmation of lower refinement due to the prominence of GO with decrease in E-476 concentration. On further reducing the E-476 concentration to 0.15 wt % as in FIG. 23(c), the deformation occurs at a strain amplitude γ=22.6% indicative of the formation of more and more larger droplets and polydispersity with the decreased E-476 molecules for refinement.

### Thermal Conductivity of the fGO Incorporated Dummy Emulsion Explosive

TABLE 2
Thermal conductivity values of different emulsions with
their corresponding ingredients and composition

| | | | | Thermal | Thermal |
|---|---|---|---|---|---|
| | | | | conductivity | conductivity |
| | | | | ‘k’ (W/mK) | ‘k’ (W/mK) |
| | Concentration | Emulsion composition | | by TCi | by Thermal |
| Emulsion with | (wt %) | (aqueous:oil) | | analyzer | Imaging |
| GO | None | 90:10 | (35 wt % salt) | 0.37 | 0.35 |
| GO (aq. phase) | 0.014 | 90:10 | (35 wt % salt) | 0.39 | 0.40 |
| fGO (oil phase) | 0.005 | 90:10 | (35 wt % salt) | 0.36 | 0.38 |
| fGO (oil phase) | 0.01 | 90:10 | (35 wt % salt) | 0.43 | 0.39 |
| fGO | None | 93.5:6.5 | (>45 wt % salt) | 0.35 | 0.37 |
| fGO (oil phase) | 0.01 | 93.5:6.5 | (>45 wt % salt) | 0.38 | 0.38 |
| fGO (oil phase) | 0.05 | 93.5:6.5 | (>45 wt % salt) | 0.40 | 0.39 |
| fGO (oil phase) | 0.1 | 93.5:6.5 | (>45 wt % salt) | 0.44 | 0.42 |

The W/O emulsion with GO were explored further for the determination of thermal conductivity at various of fGO concentration. Table 2 shows the thermal conductivity of emulsions with varying concentration at the same emulsion composition. It can be clearly seen from Table 2 that there is an enhancement in the thermal conductivity of emulsion with the increase in the fGO concentration. A mild increase in the thermal conductivity may be due to very low concentration of fGO in the total emulsion. Higher concentration makes the emulsion formation difficult due to inhibition action as discussed earlier.

### Example 4

### VoD Testing

Tests were conducted to measure VoD in a pre-formulated ammonium nitrate emulsion (ANE) explosive composition lacking graphene oxide (GO), and the pre-formulated ANE explosive composition into which graphene oxide (GO) was incorporated as an additive.

All testing was performed in 40 mm diameter cardboard tubes, 50 cm in length initiated with a 25 g booster.

The product tested was unsensitised ANE Gold DC (a commercially available ammonium nitrate emulsion explosive with an ammonium nitrate content of 80%, which can be obtained from Orica International Private Limited, Singapore) with and without the addition of GO. This commercially-available pre-formulated ANE explosive composition was selected for Example 4 because it is a representative “mid-range” ANE explosive composition with respect to its AN content. Individuals having ordinary skill in the art will readily understand that other emulsion explosive compositions can be used, which may have different AN content, yet which will show VoD results that are generally similar, similar, analogous, or comparable to the VoD results detailed below.

The GO was added in dry or powder form at 0.25% w/w directly to the pre-formed or pre-formulated emulsion explosive and mixed or blended therein until uniform. The product was then chemically sensitized by the addition of a conventional nitrite salt, which in this Example was sodium nitrite, thereby sensitising the product by way of the formation of nitrogen gas bubbles therein. Individuals having ordinary skill in the relevant art will understand that other types of nitrite salts (e.g., calcium nitrite) or other types of conventional chemical sensitizing agents could be used for sensitisation. The final product density prior to VoD testing was 1.00 g/cc or 0.95 g/cc. One test was also performed with the GO-containing product at a final density of 0.9 g/cc, but this particular commercially available emulsion explosive product lacking GO was not able to be produced down to that density.

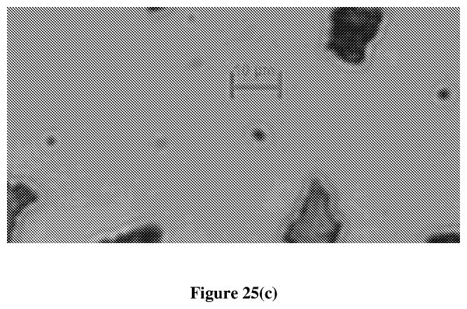

Prior to the incorporation of the GO into the product, the GO was pulse ground (by way of a conventional blade grinder) with four pulses of <1 sec each with 2 second interpulse intervals, which “cut” the as-received GO into small enough pieces or particles to allow uniform mixing, whilst maintaining the chemical structure of the GO. Images of the GO particles after pulse grinding are provided in FIGS. 25(a)-(c), where the scale in FIG. 25(b) is 100.0 μm and the scale in FIG. 25(c) is 10 μm.

VoD test data is presented in Table 3.

TABLE 3
VoD test data

| Product Density | VoD - No GO | VoD with GO |
|---|---|---|
| (g/cc) | (km/sec) | (km/sec) |
| 1.00 | 2.9 | 3.6 |
| 1.00 | 3.0 | 3.6 |
| 0.95 | 3.0 | 3.6 |
| 0.95 | 3.0 | 3.6 |
| 0.90 | — | 3.5 |
| 0.90 | — | 3.5 |

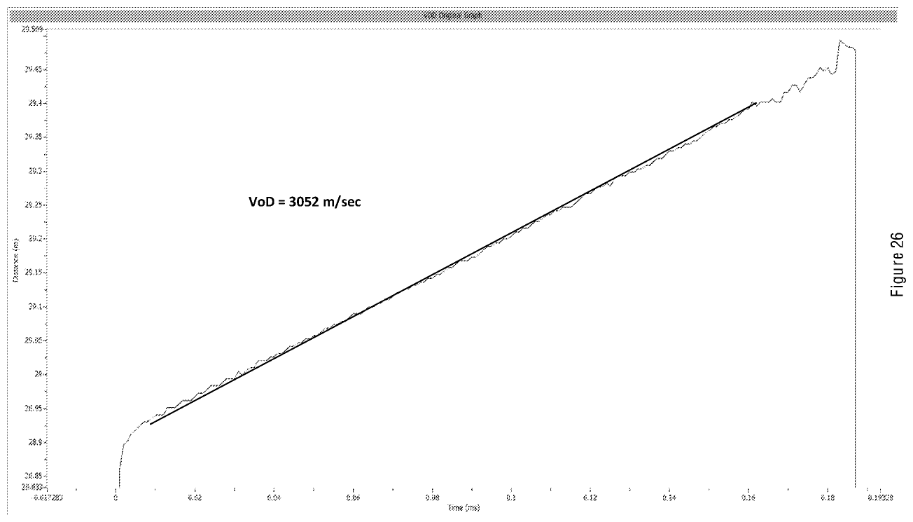

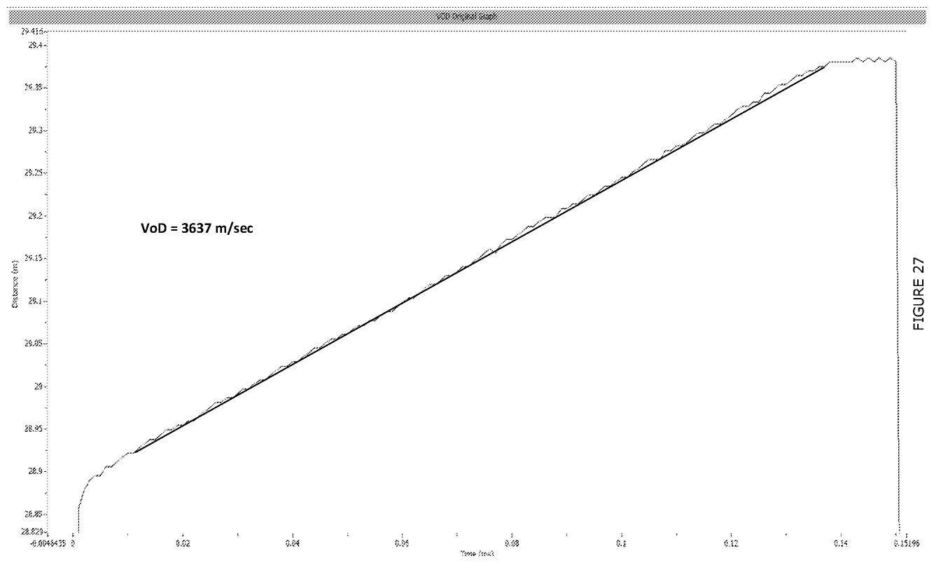

The VoD traces were all clean. An example of a VoD trace without GO and with GO are shown in FIGS. 26 and 27, respectively.

As indicated in Table 3, the tested products containing GO showed a VoD improvement of more than 15%, i.e., about 16.67%. This is a surprising result, given that the inventors named on this patent application were unaware of any other type of additive to an emulsion explosive that would be capable of providing a VoD increase of 15% or more at such a small weight percentage of additive.

### Example 5

### Differential Scanning Calorimetry (DSC) Measurements

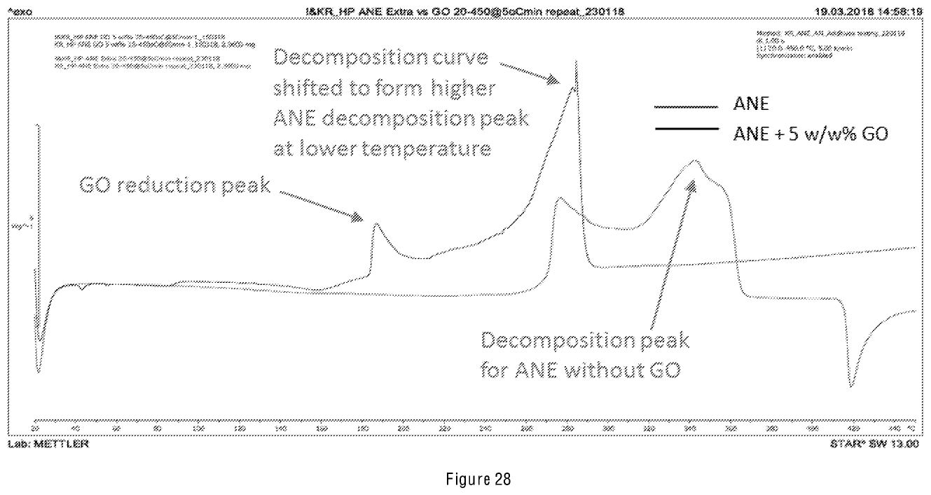

FIG. 28 shows Differential Scanning Calorimetry (DSC) measurements corresponding to another pre-formed or pre-formulated commercially available W/O emulsion explosive product, ANE Extra (also available from Orica International Private Limited, Singapore), without GO incorporated and blended therein as an additive, and with GO incorporated and blended therein as an additive at 5 wt % GO. As indicated in FIG. 28, the incorporation of GO into a pre-formulated ANE explosive product significantly or dramatically shifts the ANE decomposition peak and changes the overall shape of the exotherm profile, resulting in a much higher ANE decomposition peak at a lower temperature than for the pre-formulated ANE explosive product that lacked GO therein. Additionally, a large GO reduction peak can be seen corresponding to temperatures significantly below the shifted ANE decomposition peak.

It can be noted that from this and related DSC experiments, it was determined that the incorporation of GO the pre-formulated emulsion explosive at 5 wt % GO provided the most readily apparent or possibly optimal increase in energy of the system, based on the shape and size of the shifted ANE decomposition peak relative to the ANE decomposition peak for the pre-formulated emulsion explosive that lacked GO therein.

1. A water-in-oil (W/O) emulsion explosive comprising one or more of graphene oxide (GO), partially reduced graphene oxide (prGO) and functionalized graphene oxide (fGO).

2. The W/O emulsion explosive of claim 1 which exhibits a thermal conductivity improvement that is at least 10% greater than that of the W/O emulsion explosive in the absence of the one or more of graphene oxide (GO), partially reduced graphene oxide (prGO) and functionalized graphene oxide (fGO).

3. The W/O emulsion explosive of claim 1 which exhibits a velocity of detonation (VoD) improvement that is at least 10% greater than that of the W/O emulsion explosive in the absence of the one or more of graphene oxide (GO), partially reduced graphene oxide (prGO) and functionalized graphene oxide (fGO).

4. The W/O emulsion explosive of claim 1, which further comprising a surfactant in addition to the one or more of grapheme oxide (GO), partially reduced grapheme oxide (prGO), and functionalized grapheme oxide (fGO).

5. The W/O emulsion explosive of claim 1 which exhibits an emulsion stability of up to 20 days.

6. The W/O emulsion explosive of claim 1, wherein the one or more of graphene oxide (GO), partially reduced graphene oxide (prGO) and functionalized graphene oxide (fGO) is present in an amount of from about 0.007 wt % to about 5 wt %.

7. The W/O emulsion explosive of claim 1, wherein the one or more of graphene oxide (GO), partially reduced graphene oxide (prGO) and functionalized graphene oxide (fGO) has an average or median largest dimension ranging from about 0.1 μm to about 5 mm.

8. A method of improving one or more properties of a W/O emulsion explosive, the method comprising incorporating in the W/O emulsion explosive one or more of graphene oxide (GO), partially reduced graphene oxide (prGO) and functionalized graphene oxide (fGO), wherein said one or more improved properties is relative to the W/O emulsion explosive absent the one or more of graphene oxide (GO), partially reduced graphene oxide (prGO) and functionalized graphene oxide (fGO).

9. The method according to claim 8, wherein the one or more improved properties include one or each of improved thermal conductivity and improved velocity of detonation.

10. The method according to claim 8, wherein the one or more of graphene oxide (GO), partially reduced graphene oxide (prGO) and functionalized graphene oxide (fGO) is incorporated into the W/O emulsion explosive during or as part of an emulsification stage of preparing the W/O emulsion explosive.

11. The method according to claim 8, wherein the one or more of graphene oxide (GO), partially reduced graphene oxide (prGO) and functionalized graphene oxide (fGO) is incorporated into the W/O emulsion explosive after an emulsification stage of preparing the W/O emulsion explosive.

12. The method according to claim 8, wherein the one or more of graphene oxide (GO), partially reduced graphene oxide (prGO) and functionalized graphene oxide (fGO) is used in an amount of from about 0.007 wt % to about 5 wt %.

13. The method according to claim 8, wherein the one or more of graphene oxide (GO), partially reduced graphene oxide (prGO) and functionalized graphene oxide (fGO) has an average or median largest dimension ranging from about 0.1 μm to about 5mm.

14. Use of one or more of graphene oxide (GO), partially reduced graphene oxide (prGO) and functionalized graphene oxide (fGO) to improve one or more properties of a W/O emulsion explosive, wherein the improvement is relative to the W/O emulsion explosive absent the one or more of graphene oxide (GO), partially reduced graphene oxide (prGO) and functionalized graphene oxide (fGO).
